(19) United States
(12) Patent Application Publication
(10) Pub. No.: US 2008/0159691 A1
(43) Pub. Date: Jul. 3, 2008

(54) MULTI-CHANNEL OPTICAL COUPLING DEVICE, ELECTRONIC EQUIPMENT, LEAD FRAME MEMBER, AND FABRICATION METHOD FOR MULTI-CHANNEL OPTICAL COUPLING DEVICE

(75) Inventor: Motonari Aki, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/961,512

(22) Filed: Dec. 20, 2007

(30) Foreign Application Priority Data
Dec. 28, 2006 (JP) 2006-355349

(51) Int. Cl. G02B 6/28

(52) U.S. Cl. 385/24

(57) ABSTRACT

In one embodiment, in a multi-channel optical coupling device, which is obtained by individually encapsulating a plurality of optical coupling elements within primary packages of light transmitting resin while encapsulating them within a secondary package of light blocking resin, a lead frame is provided with a common lead used to electrically interconnect the optical coupling elements, with the common lead being partially decoupled at the boundary location between the optical coupling elements.

### CROSS REFERENCE TO RELATED APPLICATIONS

This application claims priority rights under 35 U.S.C. § 119(a) on Japanese Patent Application No. 2006-355349 filed on Dec. 28, 2006 in Japan, the entire contents of which are herein incorporated by reference.

### BACKGROUND OF THE INVENTION

1. Field of Invention

The present invention relates to a multi-channel optical coupling device, electronic equipment, and a lead frame member that can be utilized in electronic equipment such as power supply circuits and in electronic equipment such as telecommunication equipments, as well as to a fabrication method for a multi-channel optical coupling device.

2. Related Art

The principal uses of optical coupling devices include “feedback applications of switching power supplies” and “communication interface applications of FA (Factory Automation) equipment called field networks”.

For instance, multi-channel optical coupling devices, in which a plurality of optical coupling elements comprising light emitting elements and light receiving elements are placed side-by-side between a pair of lead frames may be used as this type of optical coupling devices.

Unidirectional multi-channel optical coupling devices, which are obtained by juxtaposing a plurality of optical coupling elements formed by arranging a plurality of light emitting elements disposed on one lead frame and a plurality of light receiving elements disposed on another lead frame opposite each other, and bidirectional multi-channel optical coupling devices, which are obtained by juxtaposing a plurality of optical coupling elements formed by arranging light emitting elements and light receiving elements opposite each other in an alternating fashion between a pair of lead frames, can be cited as examples of such multi-channel optical coupling devices.

Among these, bidirectional multi-channel optical coupling devices are utilized mainly as multi-channel optical coupling devices for telecommunications, for instance, as multi-channel optical coupling devices for high-speed telecommunications employed in the communication interfaces of factory automation (FA) equipment conforming to Fieldbus standards such as “Device-net”, “Profi-bus”, “Inter-bus” etc. (for example, see JP6-338778A).

In such conventional multi-channel optical coupling devices, measures aimed at minimizing light interference between adjacent optical coupling elements (channels) among the plurality of optical coupling elements are not sufficient.

Namely, in order to implement anti-interference measures in a multi-channel optical coupling device, it is necessary to ensure that the optical paths of adjacent optical coupling elements remain independent and do not interfere with each other.

This is accomplished, for instance, by a method in which the gap between the electrically isolated light emitting elements and light receiving elements is bridged using a light transmitting resin, such as silicone resin, and a package is formed by applying a light blocking resin, such as epoxy resin, on the outside thereof.

In such a method, however, there is a chance that package cracks may be induced by the expansion coefficients of the light blocking molding resin, such as an epoxy resin, and the light transmitting resin, such as a silicone resin, as a result thermal shocks associated with solder flowing/reflowing in the process of mounting.

On the other hand, there is a method called “two-stage transfer molding”, in which a plurality of optical coupling elements are individually encapsulated in primary packages of light transmitting resin while the outside of the individual primary packages is encapsulated in a secondary package of light blocking resin.

FIG. 25(a) and FIG. 25(b) are diagrams illustrating a conventional multi-channel optical coupling device having a plurality of optical coupling elements fabricated in accordance with the two-stage transfer molding method, with FIG. 25(a) being a schematic cross-section of the optical coupling device as viewed from the side and FIG. 25(b) being a schematic cross-section of the optical coupling device as viewed from the front. It should be noted that here, in order to simplify the explanation, the coupling device is exemplified for a case where it has two optical coupling elements.

A multi-channel optical coupling device 100′ is fabricated as shown, for instance, in FIG. 25(a) and FIG. 25(b), by arranging light receiving elements 3, 3 and light emitting elements 4, 4 respectively arranged on a pair of lead frames 1′, 2′ opposite each other, individually encapsulating them within primary packages 7, 7 of light transmitting resin and then encapsulating the outside of the individual primary packages 7, 7 within a secondary package 8 of light blocking resin.

FIG. 26(a) through FIG. 26(d) illustrate the process of fabrication in an example, wherein the multi-channel optical coupling device 100′ shown in FIG. 25(a) and FIG. 25(b) is manufactured in accordance with the two-stage transfer molding method.

First of all, light receiving elements 3, 3 are disposed on a lead frame member 10′ and light emitting elements 4, 4 are disposed on a lead frame member 20′ (see FIG. 26(a)), and the lead frame members 10′, 20′ are arranged opposite each other such that individual optical coupling elements P, P are formed by the light receiving elements 3, 3 and light emitting elements 4, 4 (see FIG. 26(b)).

Next, primary tie bars (not shown in the figures) provided in the lead frame members 10′, 20′, which carry the light receiving elements 3, 3 and light emitting elements 4, 4, are sandwiched between a top mold half and a bottom mold half to prevent light transmitting resin from leaking out and the light receiving elements 3, 3 and light emitting elements 4, 4 are individually encapsulated in the light transmitting resin to form primary packages 7, 7 (see FIG. 26(c)). The light conduction paths of the optical coupling elements P, P are secured by the primary packages 7, 7.

Subsequently, the primary tie bars are cut off, resin burrs consisting of the light transmitting resin are removed and, furthermore, secondary tie bars (not shown in the figures) provided in the lead frame members 10′, 20′ are sandwiched between a top mold half and a bottom mold half to prevent light blocking resin from leaking out and the outside of the individual primary packages 7, 7 is encapsulated in the light blocking resin, thereby forming a secondary package 8 (see FIG. 26(d)). Optical interference between the adjacent optical coupling elements P, P is impeded by this secondary package 8. A multi-channel optical coupling device 100′ is obtained after cutting off the secondary tie bars, removing resin burrs consisting of the light blocking resin, and executing steps such as processing external leads, etc.

In the thus fabricated multi-channel optical coupling device 100′, in each of the optical coupling elements P, P, signal transmission based on detected/emitted light is carried out with the help of the primary packages 7, 7 molded of the transmitting resin while prevention of light interference between adjacent optical coupling elements P, P is achieved with the help of the secondary package 8 molded of the light blocking resin.

It should be noted that while the illustrated example describes the manufacture of a unidirectional multi-channel optical coupling device, manufacture can be performed in the same manner in the case of a bidirectional multi-channel optical coupling device as well.

However, such a conventional multi-channel optical coupling device has the following drawbacks.

FIG. 27(a) and FIG. 27(b) are schematic plan views illustrating lead frames 1′, 2′, which carry, respectively, light receiving elements 3, 3 and light emitting elements 4, 4 of optical coupling elements P, P constituting a unidirectional multi-channel optical coupling device, with FIG. 27(a) illustrating a lead frame 1′ on the light receiving side, on which the light receiving elements 3, 3 are die-bonded and wire-bonded using metal wires 5, and FIG. 27(b) illustrating a lead frame 2′ on the light emitting side, on which the light emitting elements 4, 4 are die-bonded and wire-bonded using metal wires 5. Moreover, FIG. 28 is a diagram showing an equivalent circuit for the optical coupling device illustrated in FIG. 27(a) and FIG. 27(b).

As shown in FIG. 27(a)-FIG. 28, when, in order to achieve a decrease in the number of external terminals on the receiving-side lead frame 1′, a common lead portion 111′ is provided between the power supply (Vcc) terminals 3a, 3a of the adjacent light receiving elements 3, 3 and, at the same time, a common lead portion 112′ is provided between the ground (GND) terminals 3b, 3b of the light receiving elements 3, 3, as shown in FIG. 27(a), the common lead portions 111′, 112′ span across the boundary location Q in the gap between the adjacent optical coupling elements P, P. For this reason, as shown in FIG. 25(a), the light-blocking wall 6 in the secondary package 8 could not sufficiently shield the gap between the adjacent optical coupling elements P, P and it was difficult to make adjacent optical coupling elements P, P optically independent and non-interfering.

The same can be said with respect to bidirectional multi-channel optical coupling devices. FIG. 29 is a diagram illustrating an example of an equivalent circuit of a bidirectional multi-channel optical coupling device.

As show in FIG. 29, when one attempts to build an equivalent circuit for a bidirectional multi-channel optical coupling device using the same number of external terminals as in the above-described unidirectional multi-channel optical coupling device, the respective lead frames are provided with a common lead portion 13′ between the ground terminal 3b of the light receiving element 3 and the cathode terminal 4a of the light emitting element 4. Therefore, in the same manner as in the unidirectional multi-channel optical coupling device illustrated in FIG. 27(a)-FIG. 28, it is impossible to sufficiently block light between the optical coupling elements P, P.

### SUMMARY OF THE INVENTION

It is an object of the present invention to provide a multi-channel optical coupling device and an electronic equipment capable of effectively preventing optical interference between adjacent optical coupling elements among the plurality of optical coupling elements while reducing the number of external terminals.

Moreover, it is an object of the present invention to provide a fabrication method for a multi-channel optical coupling device and a lead frame member that make it possible to obtain a multi-channel optical coupling device capable of effectively preventing optical interference between adjacent optical coupling elements among the plurality of optical coupling elements while reducing the number of external terminals.

The present invention provides the following multi-channel optical coupling device and electronic equipment incorporating the same.

### (1) Multi-Channel Optical Coupling Device

A multi-channel optical coupling device in which a plurality of optical coupling elements, each respectively comprising a light emitting element and a light receiving element, are placed side-by-side between a pair of lead frames arranged mutually opposite each other, the plurality of optical coupling elements are encapsulated in primary packages of light transmitting resin, and the outside of the individual primary packages is encapsulated in a secondary package of light blocking resin, wherein at least one lead frame of the pair of lead frames is provided with a common lead used to electrically interconnect adjacent optical coupling elements among the plurality of optical coupling elements, with the common lead being partially decoupled at the boundary location between the adjacent optical coupling elements.

### (2) Electronic Equipment

An electronic equipment including the multi-channel optical coupling device according to the present invention.

Power supply equipments, inverter control equipments, and telecommunication equipments used in the communication interfaces of factory automation (FA) equipment can be cited as examples of the electronic equipment according to the present invention. However, it is not limited thereto and may be any sort of equipment so long as it performs signal transmission while providing input/output isolation.

The multi-channel optical coupling device and electronic equipment of the present invention permit a reduction in the number of external terminals because at least one of the lead frames is provided with a common lead used to electrically interconnect adjacent optical coupling elements among the plurality of optical coupling elements. Moreover, since the common lead is partially decoupled at the boundary location between the adjacent optical coupling elements, the adjacent optical coupling elements can be reliably shielded by the light-blocking wall in the secondary package, thereby making it possible to reliably block light between the adjacent optical coupling elements. Accordingly, it becomes possible to effectively prevent optical interference between the adjacent optical coupling elements while reducing the number of external terminals.

In the multi-channel optical coupling device and electronic equipment according to the present invention, the light emitting elements and light receiving elements may be arranged opposite to and alternating with each other between the pair of lead frames. Doing so makes it possible to easily implement two-way communication.

This may be exemplified by an embodiment, in which the common lead comprises a common lead portion shared between a ground terminal of the light receiving element and a cathode terminal of the light emitting element. Doing so permits a reduction in the number of external terminals associated with the ground terminal of the light receiving element and the cathode terminal of the light emitting element.

Thus, the situation wherein the common lead comprises a common lead portion shared between the ground terminal of the light receiving element and the cathode terminal of the light emitting element can be exemplified by the following specific embodiments.

(a) An embodiment, in which the common lead portion has a first header portion carrying the light receiving element and a second header portion carrying the light emitting element, the ground terminal of the light receiving element is electrically connected to the first header portion, and the cathode terminal of the light emitting element is directly attached to the second header portion.

(b) An embodiment, in which the common lead portion has a header portion carrying the light receiving element and also has a lead used for the cathode of the light emitting element, the ground terminal of the light receiving element is electrically connected to the header portion, and the cathode terminal of the light emitting element is electrically connected to the cathode lead using a metal wire.

In Embodiment (a) above, it becomes possible to mount the light emitting elements such that the cathode terminals directly attached to the corresponding lead frames. In addition, in Embodiment (b) above, it becomes possible to mount the light emitting elements such that the anode terminals are directly attached to the corresponding lead frames.

In the multi-channel optical coupling device and electronic equipment according to the present invention, the plurality of optical coupling elements may each comprise an emitter-driving element that drives the light emitting element. Doing so permits direct driving of these light emitting elements in the optical coupling elements and, as a result enables fast response by the light emitting elements and accordingly permits high-speed communication response in field networks of FA equipment and the like.

This can be exemplified by an embodiment, in which the plurality of optical coupling elements have the light emitting elements and light receiving elements arranged to opposite each other in an alternating fashion and the common lead comprises a common lead portion shared between a ground terminal of the emitter-driving element, a ground terminal of the light receiving element, and a cathode terminal of the light emitting element. Doing so makes it possible to decrease the number of external terminals associated with the ground terminal of the emitter-driving element, the ground terminal of the light receiving element and the cathode terminal of the light emitting element.

Thus, the situation wherein the common lead comprises a common lead portion shared between the ground terminal of the emitter-driving element, the ground terminal of the light receiving element, and the cathode terminal of the light emitting element, can be exemplified by the following specific embodiments.

(c) An embodiment, in which the common lead portion has a first header portion carrying the light receiving element and a second header portion carrying both the light emitting element and the emitter-driving element the ground terminal of the light receiving element is electrically connected to the first header portion, the cathode terminal of the light emitting element is directly attached to the second header portion, and the ground terminal of the emitter-driving element is electrically connected to the second header portion.

(d) An embodiment, in which the common lead portion has a first header portion carrying the light receiving element and a second header portion carrying the emitter-driving element, the ground terminal of the light receiving element is electrically connected to the first header portion, the cathode terminal of the light emitting element is electrically connected to the second header portion or to a lead of the second header portion using a metal wire, and the ground terminal of the emitter-driving element is electrically connected to the second header portion.

In Embodiment (c) above, it becomes possible to mount the light emitting elements such that the cathode terminals are directly attached to the corresponding lead frames. In addition, in Embodiment (d) above, it becomes possible to mount the light emitting elements such that the anode terminals are directly attached to the corresponding lead frames.

Furthermore, this can be exemplified by an embodiment, in which each of the plurality of optical coupling elements comprises an emitter-driving element that drives the light emitting element and the common lead comprises a common lead portion shared between a power supply terminal of the emitter-driving element and a power supply terminal of the light receiving element. Doing so permits a reduction in the number of external terminals associated with the power supply terminal of the emitter-driving element and the power supply terminal of the light receiving element.

In the multi-channel optical coupling device and electronic equipment according to the present invention, the common lead is preferably electrically connected outside of the location of deflection of the lead frame towards the element-carrying side and within the secondary package. In this case, it becomes possible to stably maintain excellent electrical connections between the adjacent optical coupling elements over an extended period of time because the electrical connection is within the secondary package.

Moreover, in this case, the common lead is preferably electrically connected using at least one of a tie bar, lead, or metal wire. Doing so makes it possible to simply and easily implement electrical connections between the adjacent optical coupling elements.

As used herein, the above-mentioned term “tie bar” refers to an auxiliary lead unit providing support between the leads of the lead frame members and, in some cases, possessing features intended to reduce resin leakage during resin encapsulation.

The present invention also provides the following lead frame member and fabrication method for a multi-channel optical coupling device.

### (3) Lead Frame Member

A lead frame member used in a multi-channel optical coupling device in which a plurality of optical coupling elements, each respectively comprising a light emitting element and a light receiving element, are placed side-by-side between a pair of lead frames arranged mutually opposite each other, the plurality of optical coupling elements are encapsulated in primary packages of light transmitting resin, and the outside of the individual primary packages is encapsulated in a secondary package of light blocking resin, wherein there is provided a common lead used to electrically interconnect adjacent optical coupling elements among the plurality of optical coupling elements and the common lead is at least partially decoupled at the boundary location between the adjacent optical coupling elements.

### (4) Fabrication Method for a Multichannel Optical Coupling Device

A fabrication method for a multi-channel optical coupling device in which a plurality of optical coupling elements, each respectively comprising a light emitting element and a light receiving element, are placed side-by-side between a pair of lead frames arranged mutually opposite each other, the plurality of optical coupling elements are encapsulated in primary packages of light transmitting resin, and the outside of the individual primary packages is encapsulated in a secondary package of light blocking resin, the fabrication method comprising the steps of: a lead frame member preparation step, which involves preparing first and second lead frame members, and, as at least one lead frame member among the first and second lead frame members, employing a lead frame member in which a common lead is provided that electrically interconnects adjacent optical coupling elements among the plurality of optical coupling elements and the common lead is at least partially decoupled at the boundary location between the adjacent optical coupling elements; an optical coupling element formation step, which involves forming the plurality of optical coupling elements by placing light emitting elements and light receiving elements constituting the optical coupling elements on the first and second lead frame members; a primary package formation step, which involves forming the primary packages by individually encapsulating the plurality of optical coupling elements with light transmitting resin; a lead frame member processing step, which involves, subsequent to the primary package formation step, processing the lead frame member employed in the lead frame member preparation step to a state of electrical interconnection between the adjacent optical coupling elements; and a secondary package formation step, which involves forming the secondary package by encapsulating the outside of the individual primary packages with light blocking resin.

Using the inventive lead frame member and fabrication method for a multi-channel optical coupling device makes it possible to obtain the inventive multi-channel optical coupling device by employing the inventive lead frame member in the lead frame member preparation step, forming primary packages in the primary package formation step, and then, in the lead frame member processing step, processing the lead frame members to a state of electrical interconnection between the adjacent optical coupling elements. Accordingly, a multi-channel optical coupling device can be obtained that is capable of effectively preventing optical interference between adjacent optical coupling elements while reducing the number of external terminals.

The lead frame member according to the present invention may be adapted for use in a multi-channel optical coupling device, in which the light emitting elements and light receiving elements are arranged opposite to and alternating with each other.

Namely, in the inventive fabrication method for a multi-channel optical coupling device, the first and second lead frame members prepared in the lead frame member preparation step are used in a multi-channel optical coupling device having light emitting elements and light receiving elements arranged opposite to and alternating with each other between the pair of lead frames, and, in the optical coupling element formation step, the light emitting elements and light receiving elements may be disposed on the first and second lead frame member in an alternating fashion. As a result, the multi-channel optical coupling device that has light emitting elements and light receiving elements arranged opposite to and alternating with each other between a pair of lead frame members makes it possible to obtain a multi-channel optical coupling device that, for example, readily permits two-way communication.

In the lead frame member according to the present invention, the common lead preferably comprises a connecting portion that can be electrically connected outside of the location of deflection towards the element-carrying side and within the region corresponding to the secondary package.

Namely, in the inventive fabrication method for a multi-channel optical coupling device, the common lead of the lead frame member employed in the lead frame member preparation step preferably comprises a connecting portion that can be electrically connected outside of the location of deflection of the lead frame member towards the element-carrying side and within the region corresponding to the secondary package. In this case, it becomes possible to stably maintain excellent electrical connections between the adjacent optical coupling elements over an extended period of time because the common lead is electrically connected within the region corresponding to the secondary package.

In addition, in this case, in the lead frame member according to the present invention, the connecting portion preferably comprises at least one location selected from among a location having incorporated therein a tie bar electrically interconnecting the adjacent optical coupling elements, a location having incorporated therein a lead electrically interconnecting the adjacent optical coupling elements, and a location where it is possible to provide a metal wire electrically interconnecting the adjacent optical coupling elements.

In other words, in the inventive fabrication method for a multi-channel optical coupling device, the connecting portion of the lead frame member employed in the lead frame member preparation step preferably comprises at least one location selected from among a location having incorporated therein a tie bar electrically interconnecting the adjacent optical coupling elements and a location having incorporated therein a lead electrically interconnecting the adjacent optical coupling elements, and, in the lead frame member processing step, tie bar cutting is preferably carried out such that at least one of the tie bar and the lead is left intact. Alternatively, or additionally, the connecting portion of the lead frame member employed in the lead frame member preparation step preferably comprises a location where it is possible to provide a metal wire electrically interconnecting the adjacent optical coupling elements, with the metal wire preferably provided in the connecting portion in the lead frame member processing step. Doing so makes it possible to simply and easily implement electrical connections between the adjacent optical coupling elements.

It should be noted that the lead frame member processing step, prior to the step of providing a metal wire in the connecting portion, may further include a step of cleaning the connecting portion.

As explained above, the present invention makes it possible to provide a multi-channel optical coupling device and an electronic equipment capable of effectively preventing optical interference between adjacent optical coupling elements among a plurality of optical coupling elements while reducing the number of external terminals.

Moreover, the present invention makes it possible to provide a fabrication method for a lead frame member and a multi-channel optical coupling device that make it possible to obtain a multi-channel optical coupling device capable of effectively preventing optical interference between adjacent optical coupling elements among a plurality of optical coupling elements while reducing the number of external terminals.

### BRIEF DESCRIPTION OF THE DRAWINGS

FIG. 1(a) and FIG. 1(b) are diagrams illustrating an embodiment of the multi-channel optical coupling device of the present invention, with FIG. 1(a) being a schematic cross-section of the optical coupling device as viewed from the side and FIG. 1(b) being a schematic cross-section of the optical coupling device as viewed from the front.

FIG. 2 is a schematic plan view highlighting one of the lead frames used in the multi-channel optical coupling device illustrated in FIG. 1(a) and FIG. 1(b).

FIG. 3 is a schematic plan view highlighting one of the lead frames used in an alternative example of the multi-channel optical coupling device illustrated in FIG. 1(a)˜FIG. 2.

FIG. 4 is a schematic plan view highlighting one of the lead frames used in another example of the multi-channel optical coupling device illustrated in FIG. 1(a)-FIG. 2.

FIG. 5 is a diagram illustrating an equivalent circuit of the multi-channel optical coupling device illustrated in FIG. 4.

FIG. 6 is a schematic plan view highlighting one of the lead frames used in an alternative example of the multi-channel optical coupling device illustrated in FIG. 4.

FIG. 7 is a schematic plan view highlighting one of the lead frames used in the multichannel optical coupling device illustrated in FIG. 4 in the case where the common lead comprises a common second lead portion shared between the power supply terminal of the emitter driving element and a power supply terminal of the light receiving element.

FIG. 8 is a schematic plan view highlighting one of the lead frames used in the multi-channel optical coupling device illustrated in FIG. 6 in the case where the common lead comprises a common second lead portion shared between the power supply terminal of the emitter driving element and a power supply terminal of the light receiving element.

FIG. 9 is a schematic plan view highlighting one of the lead frames used in the multi-channel optical coupling device illustrated in FIG. 3 in the case where the common lead portion contained in the common lead is electrically connected using a lead provided in parallel to the tie bar.

FIG. 10 is a schematic plan view highlighting one of the lead frames used in the multi-channel optical coupling device illustrated in FIG. 3 in the case where the common lead portion contained in the common lead is electrically connected using a metal wire.

FIG. 11 is a schematic plan view highlighting one of the lead frames used in the multi-channel optical coupling device illustrated in FIG. 7 in the case where the common first lead portion contained in the common lead is electrically connected using a metal wire.

FIG. 12 is a schematic plan view highlighting one of the lead frames used in the multi-channel optical coupling device illustrated in FIG. 8 in the case where the common first lead portion contained in the common lead is electrically connected using a metal wire.

FIG. 13 is a schematic plan view highlighting one of the lead frame members used in the optical coupling element formation step among the steps involved in the fabrication of the multi-channel optical coupling device illustrated in FIG. 3.

FIG. 14 is a schematic plan view highlighting one of the lead frame members used in the primary package formation step among the steps involved in the fabrication of the multi-channel optical coupling device illustrated in FIG. 3.

FIG. 15 is a schematic plan view highlighting one of the lead frame members used in the lead frame member processing step among the steps involved in the fabrication of the multi-channel optical coupling device illustrated in FIG. 3.

FIG. 16 is a schematic plan view illustrating a lead frame member used in the multi-channel optical coupling device illustrated in FIG. 9.

FIG. 17 is a schematic plan view illustrating a lead frame member used in the multi-channel optical coupling device illustrated in FIG. 1(a)-FIG. 2.

FIG. 18 is a schematic plan view illustrating a lead frame member used in the multi-channel optical coupling device illustrated in FIG. 4.

FIG. 19 is a schematic plan view illustrating a lead frame member used in the multi-channel optical coupling device illustrated in FIG. 6.

FIG. 20 is a diagram illustrating a situation, wherein the common lead used in the multi-channel optical coupling device comprising emitter-driving elements illustrated in FIG. 7 comprises a common lead portion between the power supply terminals of the emitter driving elements and the power supply terminals of the light receiving elements.

FIG. 21 is a diagram illustrating a situation, wherein the common lead used in the multi-channel optical coupling device comprising emitter-driving elements illustrated in FIG. 8 comprises a common lead portion between the power supply terminals of the emitter driving elements and the power supply terminals of the light receiving elements.

FIG. 22 is a schematic plan view highlighting one of the lead frame members used in the multi-channel optical coupling device illustrated in FIG. 10.

FIG. 23 is a schematic plan view highlighting one of the lead frame members used in the multi-channel optical coupling device illustrated in FIG. 11.

FIG. 24 is a schematic plan view highlighting one of the lead frame members used in the multi-channel optical coupling device illustrated in FIG. 12.

FIG. 25(a) and FIG. 25(b) are diagrams illustrating a conventional multi-channel optical coupling device having a plurality of optical coupling elements fabricated in accordance with the two-stage transfer molding method, with FIG. 25(a) being a schematic cross-section of the optical coupling device as viewed from the side and FIG. 25(b) being a schematic cross-section of the optical coupling device as viewed from the front.

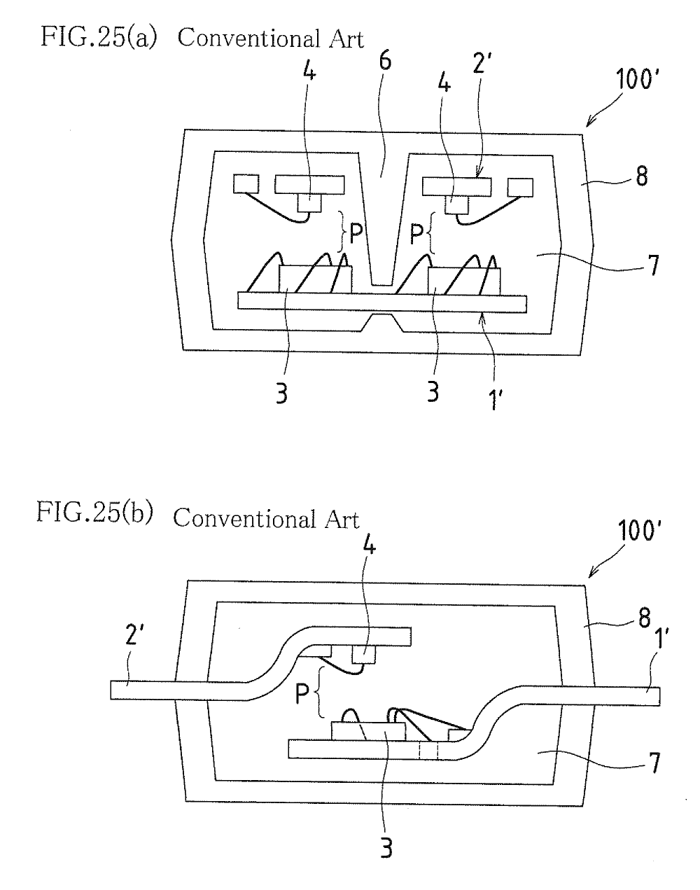

FIG. 26(a) through FIG. 26(d) are diagrams illustrating the process of fabrication in an example, wherein the multi-channel optical coupling device shown in FIG. 25(a) and FIG. 25(b) is manufactured in accordance with the two-stage transfer molding method.

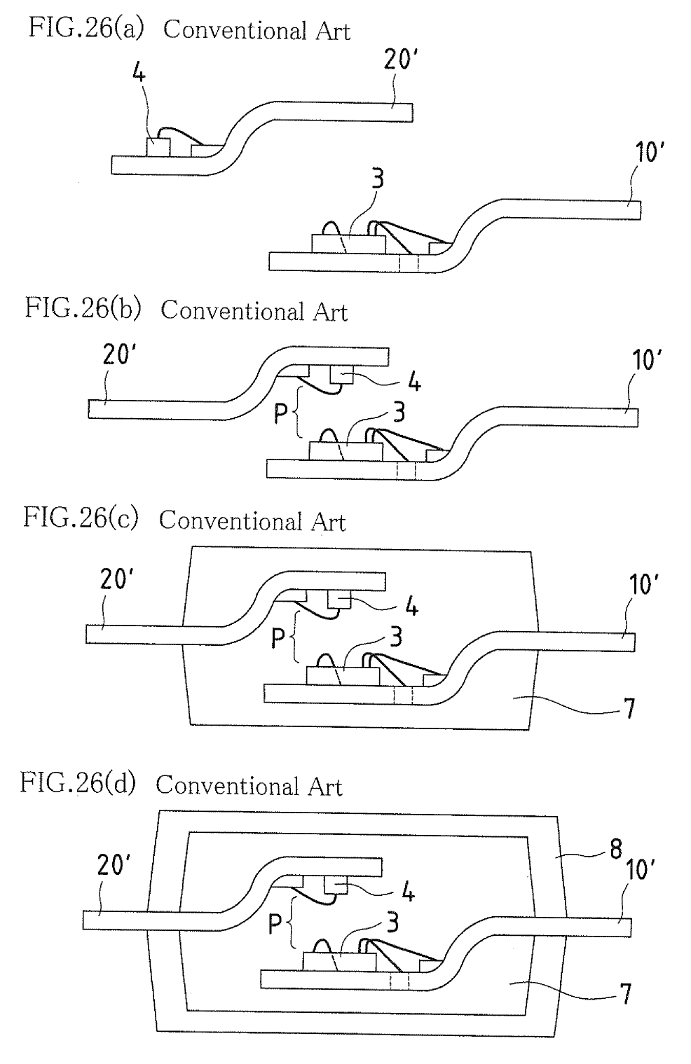

FIG. 27(a) and FIG. 27(b) are schematic plan views illustrating lead frames, which carry, respectively, the light receiving elements and light emitting elements of optical coupling elements P, P constituting a unidirectional multi-channel optical coupling device, with FIG. 27(a) illustrating a lead frame on the light receiving side, on which the light receiving elements are die-bonded and wire-bonded using metal wires, and FIG. 27(b) illustrating a lead frame on the light emitting side, on which the light emitting elements are die-bonded and wire-bonded using metal wires.

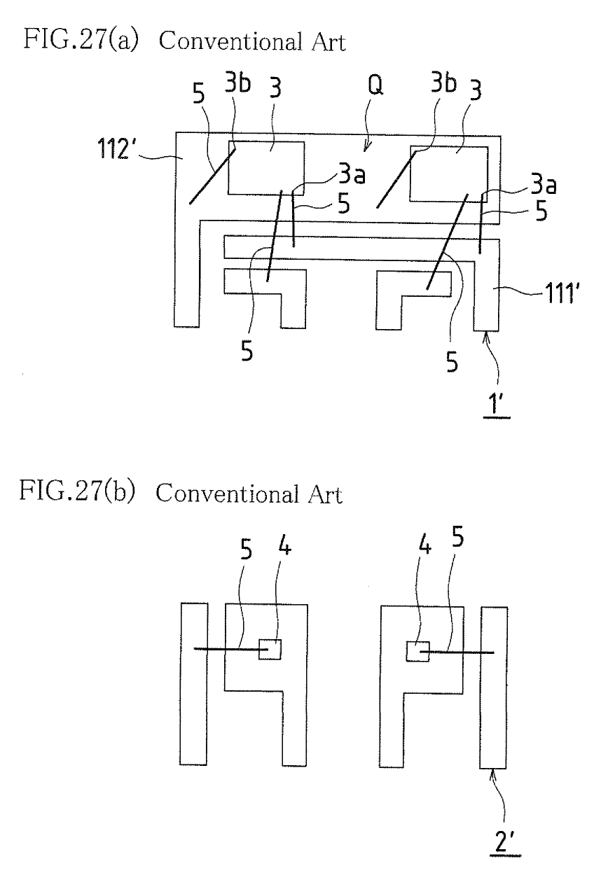

FIG. 28 is a diagram showing an equivalent circuit of the optical coupling device illustrated in FIG. 27(a) and FIG. 27(b).

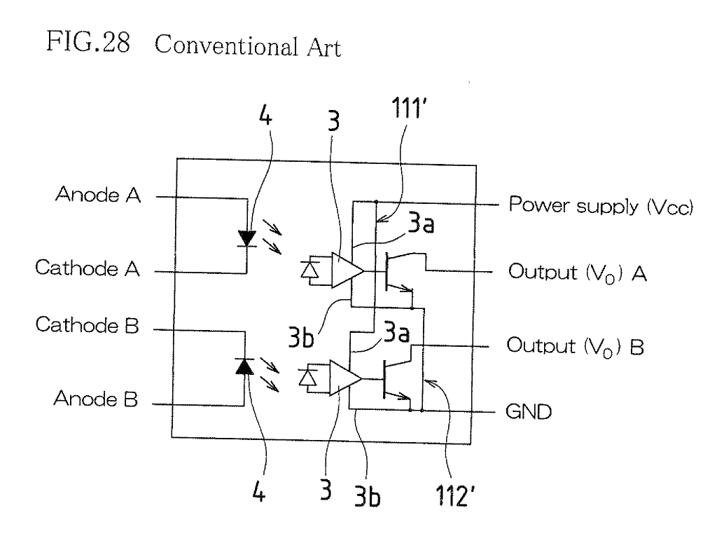

FIG. 29 is a diagram illustrating an example of an equivalent circuit of a bidirectional multi-channel optical coupling device.

### DESCRIPTION OF THE PREFERRED EMBODIMENTS

The embodiments of the present invention are explained in detail by referring to the attached drawings.

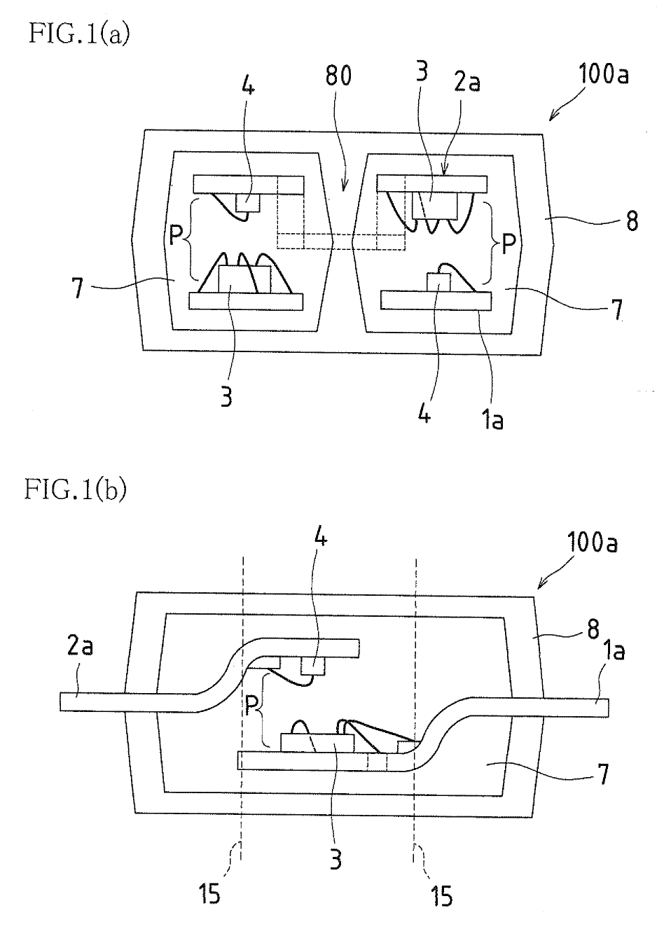

FIG. 1(a) and FIG. 1(b) are diagrams illustrating an embodiment of the multi-channel optical coupling device of the present invention, with FIG. 1(a) being a schematic cross-section of the optical coupling device as viewed from the side and FIG. 1(b) being a schematic cross-section of the optical coupling device as viewed from the front.

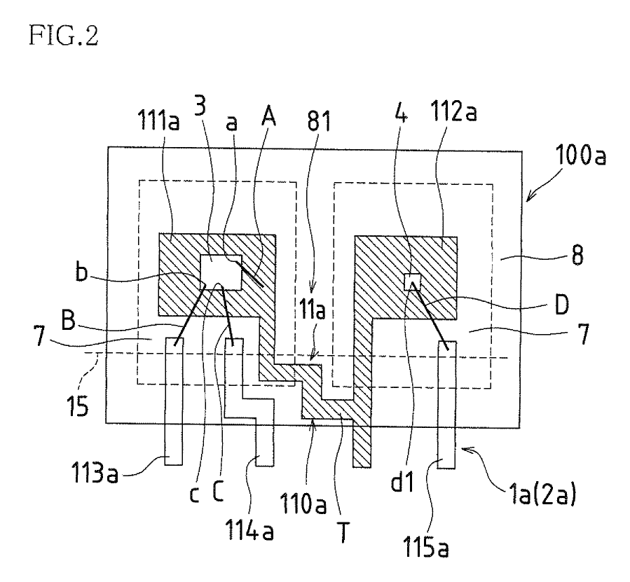

FIG. 2 is a schematic plan view highlighting one of the lead frames 1a used in the multi-channel optical coupling device 100a illustrated in FIG. 1(a) and FIG. 1(b).

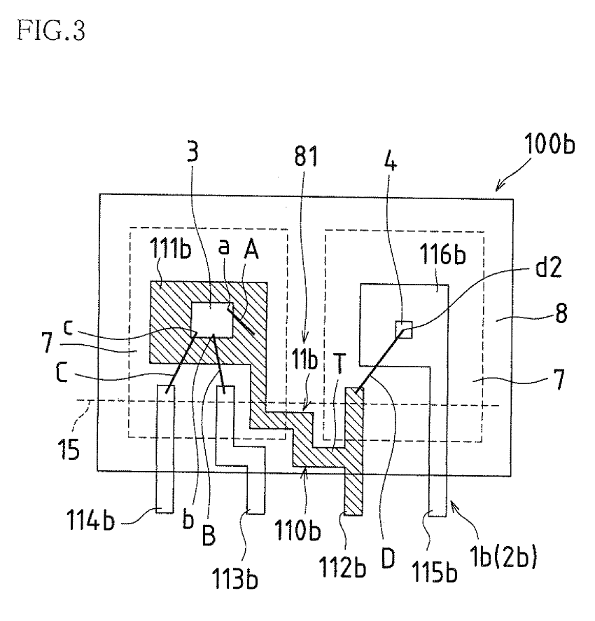

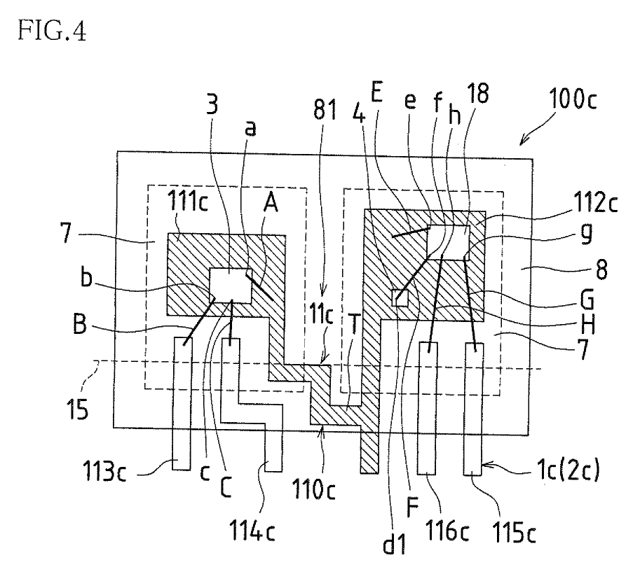

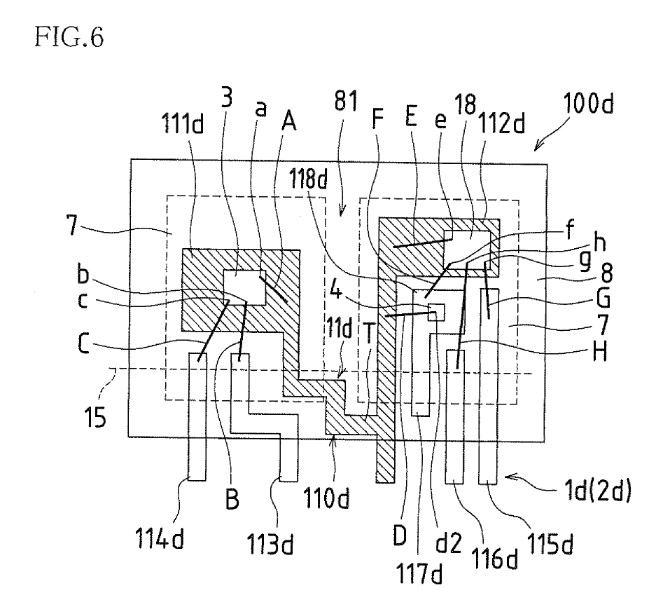

It should be noted that, in FIG. 2, the configuration of the other lead frame 2a illustrated in FIG. 1(a) and FIG. 1(b) is substantially identical to the configuration of the first lead frame 1a and is represented thereby in FIG. 2. Accordingly, in FIG. 2, the other lead frame 2a is shown in parentheses after reference numeral 1a. The same is also true with respect to the second lead frames 2b-2d in the later described FIG. 3, FIG. 4, and FIG. 6-FIG. 12.

In the multi-channel optical coupling device 100a illustrated in FIG. 1(a)-FIG. 2, a plurality of optical coupling elements P, P which respectively comprise light emitting elements 4, 4 . . . and light receiving elements 3, 3, are placed side by side between a pair of lead frames 1, 2 arranged mutually opposite to each other. While the plurality of optical coupling elements P, P . . . are individually encapsulated in primary packages 7, 7 of light transmitting resin, the outside of the individual primary packages 7, 7 is encapsulated in a secondary package 8 of light blocking resin.

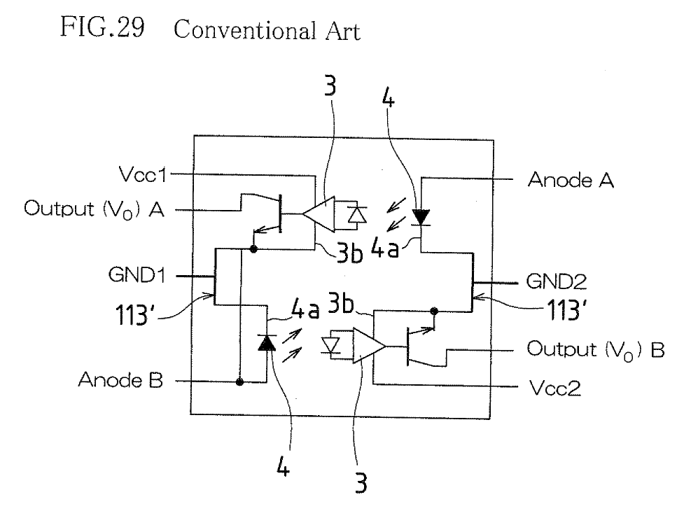

It should be noted that, in order to simplify the explanation, the discussion herein provides an example of a bidirectional multi-channel optical coupling device, such as the one represented by the equivalent circuit shown in FIG. 29, which has two optical coupling elements P, P, and the explanations below will refer to two optical coupling elements.

At least one frame (here, both lead frames 1a, 2a) of the two lead frames 1a, 2a is provided with a common lead 11a used to electrically interconnect adjacent optical coupling elements P, P. This common lead 11a is partially decoupled at the boundary location 81 between the adjacent optical coupling elements P, P.

Thus, when the multi-channel optical coupling device 100a illustrated in FIG. 1(a) FIG. 2 is used, the number of external terminals can be reduced because the lead frames 1a, 2a are provided with the common lead 11a used to electrically interconnect the adjacent optical coupling elements P, P. Moreover, since the common lead 11a is partially decoupled at the boundary location 81 between the adjacent optical coupling elements P, P, the adjacent optical coupling elements P, P can be reliably shielded by a light-blocking wall 80 in the secondary package 8, thereby making it possible to reliably block light between the adjacent optical coupling elements P, P. Accordingly, it becomes possible to effectively prevent optical interference between the adjacent optical coupling elements P, P while reducing the number of external terminals.

In order to easily implement two-way communication in the multi-channel optical coupling device 10a of the present embodiment, a plurality of optical coupling elements P, P, in which light emitting elements 4 and light receiving elements 3 are arranged opposite to and alternating with each other, are placed side by side between a pair of lead frames 1a, 2a.

Specifically, the common lead 11a comprises a common lead portion 110a (see the hatched portion in FIG. 2), which is shared so as to electrically connect the ground terminal “a” of the light receiving element 3 to the cathode terminal of the light emitting element 4. In this configuration, the external terminal, to which the ground terminal “a” of the light receiving element 3 is electrically connected, and the external terminal, to which the cathode terminal of the light emitting element 4 is electrically connected, can be used for both, thereby permitting a reduction in the number of external terminals.

The common lead portion 110a has a first header portion 111a carrying the light receiving element 3 and a second header portion 112a carrying the light emitting element 4.

The ground terminal “a” of the light receiving element 3 is directly attached to the first header portion 111a or electrically connected thereto using a metal wire (here, metal wire A). The cathode terminal of the light emitting element 4 is directly attached to the second header portion 112a.

In this configuration, it becomes possible to mount the light emitting elements 4 such that the cathode terminals are directly attached to the lead frames 1a, 2a.

To explain this in further detail, the lead frames 1a, 2a are further provided with an output lead 113a used for the light receiving element 3, a power supply lead 114a used for the light receiving element 3, and an anode lead 115a used for the light emitting element 4.

The output (Vo) terminal “b” and power supply (Vcc) terminal “c” of the light receiving element 3 are respectively electrically connected to the output lead 113a and power supply lead 114a of the light receiving element 3 using metal wires B and C. Moreover, the anode terminal “d1” of the light emitting element 4 is electrically connected to the anode lead 115a of the light emitting element 4 using a metal wire D.

FIG. 3 is a schematic plan view highlighting one of the lead frames 1b used in an alternative example of the multi-channel optical coupling device 10a illustrated in FIG. 1(a)-FIG. 2.

It should be noted that locations possessing substantially the same configuration and action in FIG. 1(a)-FIG. 3 and in the later explained FIG. 4-FIG. 24 are assigned the same reference numerals and their explanation is omitted.

In the lead frames 1b, 2b of the multi-channel optical coupling device 100b illustrated in FIG. 3, the common lead 11b comprises a common lead portion 110b shared by the ground terminal “a” of the light receiving element 3 and the cathode terminal “d2” of the light emitting element 4 (see the hatched portion in FIG. 3).

The common lead portion 110b has a header portion 111b carrying the light receiving element 3 and a cathode lead 112b used for the light emitting element 4.

The ground terminal “a” of the light receiving element 3 is directly attached to the header portion 111b or electrically connected thereto using a metal wire (here, metal wire A). The cathode terminal d2 of the light emitting element 4 is electrically connected to the cathode lead 112b using a metal wire D.

In this configuration, it becomes possible to mount the light emitting elements 4 such that the anode terminals are directly attached to the lead frames 1b, 2b.

To explain this in further detail, the lead frames 1b, 2b are further provided with an output lead 113b used for the light receiving element 3, a power supply lead 114b used for the light receiving element 3, and an anode lead 115b used for the light emitting element 4.

The anode lead 115b of the light emitting element 4 has a header portion 116b carrying the light emitting element 4. Additionally, the output (Vo) terminal “b” and power supply (Vcc) terminal “c” of the light receiving element 3 are respectively electrically connected to the output lead 113b and power supply lead 114b of the light receiving element 3 using metal wires B and C. Moreover, the anode terminal of the light emitting element 4 is directly attached to the header portion 116b of the anode lead 115b of the light emitting element 4.

FIG. 4 is a schematic plan view highlighting one of the lead frames 1c used in another example of the multi-channel optical coupling device 100a illustrated in FIG. 1(a)-FIG. 2.

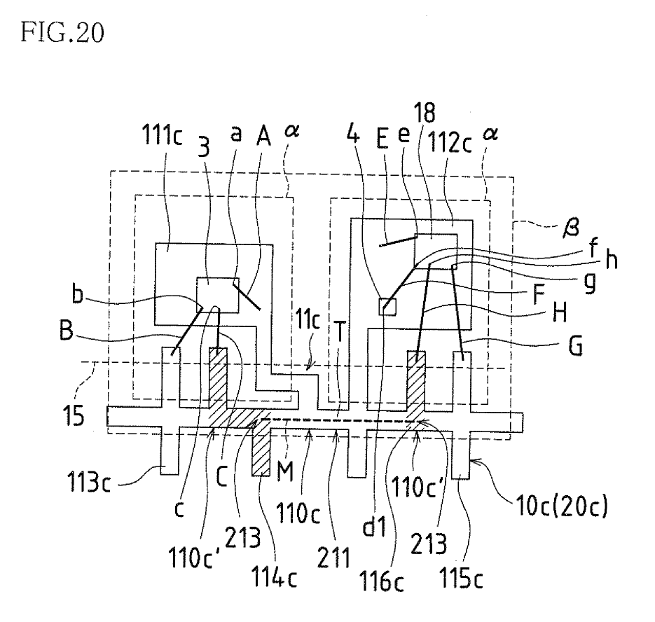

In the multi-channel optical coupling device 100c illustrated in FIG. 4, unlike the multi-channel optical coupling device 100a of FIG. 1(a) FIG. 20, each of the plurality of optical coupling elements P, P comprises an emitter-driving element 18 driving the light emitting element 4. This multi-channel optical coupling device 110c permits direct driving of the light emitting elements 4 in the optical coupling elements P and, as a result, enables fast response by the light emitting elements 4 and accordingly permits high-speed communication response in field networks of FA equipment and the like.

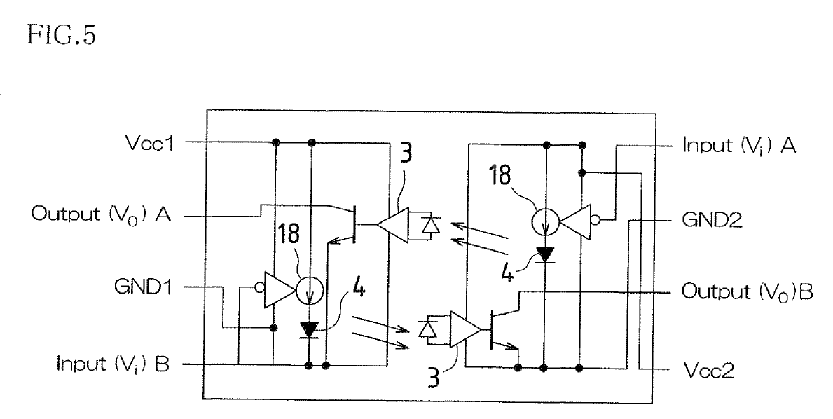

It should be noted that the discussion herein provides an example of a bidirectional multi-channel optical coupling device, such as the one represented by the equivalent circuit shown in FIG. 5, and the explanations below will refer to two optical coupling elements.

In the lead frames 1c, 2c of the multi-channel optical coupling device 100c illustrated in FIG. 4, the common lead 11c comprises a common first lead portion 110c shared by the ground terminal “e” of the emitter-driving element 18, the ground terminal “a” of the light receiving element 3, and the cathode terminal of the light emitting element 4 (see the hatched portion in FIG. 4). As a result, the external terminal, to which the ground terminal “e” of the emitter-driving element 18 is electrically connected, the external terminal, to which the ground terminal “a” of the light receiving element 3 is electrically connected, and the external terminal, to which the cathode terminal of the light emitting element 4 is electrically connected, can be used for all of them, thereby permitting a reduction in the number of external terminals.

The common first lead portion 110c has a first header portion 111c carrying the light receiving element 3, and a second header portion 112c carrying both the light emitting element 4 and the emitter-driving element 18.

The ground terminal “a” of the light receiving element 3 is directly attached to the first header portion 111c or electrically connected thereto using a metal wire (here, metal wire A). The cathode terminal of the light emitting element 4 is directly attached to the second header portion 112c. The ground terminal “e” of the emitter-driving element 18 is directly attached to the second header portion 112c or electrically connected thereto using a metal wire (here, metal wire E).

In this configuration, it becomes possible to mount the light emitting elements 4 such that the cathode terminals are directly attached to the lead frames 1c, 2c.

To explain this in further detail, the lead frames 1c, 2c are further provided with an output lead 113c used for the light receiving element 3, a power supply lead 114c used for the light receiving element 3, an input lead 115c used for the emitter-driving element 18, and a power supply lead 116c used for the emitter-driving element 18.

The output (Vo) terminal “b” and power supply (Vcc) terminal “c” of the light receiving element 3 are respectively electrically connected to the output lead 113c and power supply lead 114c of the light receiving element 3 using metal wires B and C. Moreover, the output (Vo) terminal “f” of the emitter-driving element 18 is electrically connected to the anode terminal “d1” of the light emitting element 4 using a metal wire F. Additionally, the input (Vi) terminal “g” and power supply (Vcc) terminal “h” of the emitter-driving element 18 are respectively electrically connected to the input lead 115c and power supply lead 116c of the emitter-driving element 18 using metal wires G and H.

FIG. 6 is a schematic plan view highlighting one of the lead frames 1d used in an alternative example of the multi-channel optical coupling device 10c illustrated in FIG. 4.

The multi-channel optical coupling device 100d illustrated in FIG. 6, in the same manner as in the multi-channel optical coupling device 100c of FIG. 4, comprises an emitter-driving element 18, and the common lead 11d comprises a common first lead portion 110d shared by the ground terminal “e” of the emitter-driving element 18, the ground terminal “a” of the light receiving element 3, and the cathode terminal “d2” of the light emitting element 4 (see hatched portion in FIG. 6).

The common first lead portion 110d has a first header portion 111d carrying the light receiving element 3 and a second header portion 112d carrying the emitter-driving element 18.

The ground terminal “a” of the light receiving element 3 is directly attached to the first header portion 111d or electrically connected thereto using a metal wire (here, metal wire A). The cathode terminal “2d” of light emitting element 4 is electrically connected to the second header portion 112d or its lead (here, the lead of the second header portion 112d) using a metal wire D. Moreover, the ground terminal “e” of the emitter-driving element 18 is directly attached to the second header portion 112d or electrically connected thereto using a metal wire (here, metal wire E).

In this configuration, it becomes possible to mount the light emitting elements 4 such that the anode terminals are directly attached to the lead frames 1d, 2d.

To explain this in further detail, the lead frames 1d, 2d are further provided with an output lead 113d used for the light receiving element 3, a power supply lead 114d used for the light receiving element 3, an input lead 115d used for the emitter-driving element 18, a power supply lead 116d used for the emitter-driving element 18, and the anode lead 117d used for the light emitting element 4.

The anode lead 117d of the light emitting element 4 has a header portion 118d carrying the light emitting element 4. Additionally, the output (Vo) terminal “b” and power supply (Vcc) terminal “c” of the light receiving element 3 are respectively electrically connected to the output lead 113d and power supply lead 114d of the light receiving element 3 using metal wires B and C. The anode terminal of the light emitting element 4 is directly attached to the header portion 118d of the anode lead 117d of the light emitting element 4. The output (Vo) terminal “C” of the emitter-driving element 18 is electrically connected to the anode lead 117d of the light emitting element 4 or to the header portion 118d of said anode lead 117d (here, the header portion 118d) using a metal wire F. Additionally, the input (Vi) terminal “g” and power supply (Vcc) terminal “h” of the emitter-driving element 18 are respectively electrically connected to the input lead 115d and power supply lead 116d of the emitter-driving element 18 using metal wires G and H.

It should be noted that, in the lead frames 1c, 2c and 1d, 2d illustrated in FIG. 4 and FIG. 6, the common leads 11c and 11d may comprise a common lead portion shared by the power supply (Vcc) terminal “h” of the emitter-driving element 18 and the power supply terminal “c” of the light receiving element 3.

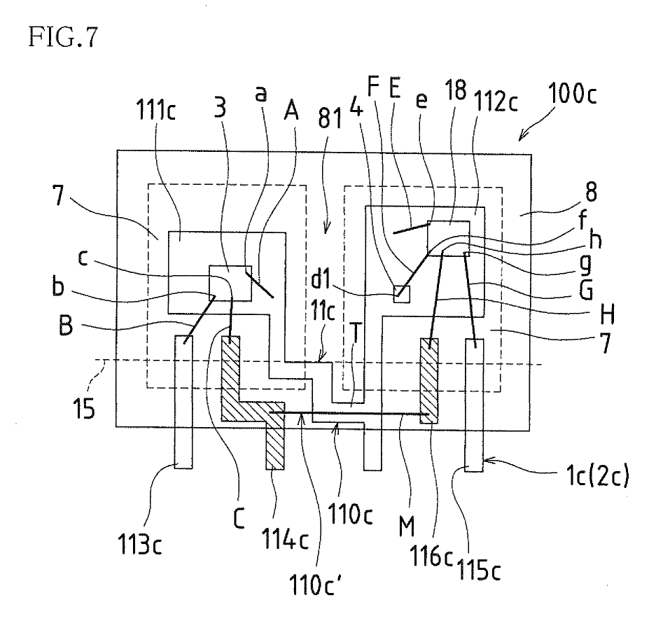

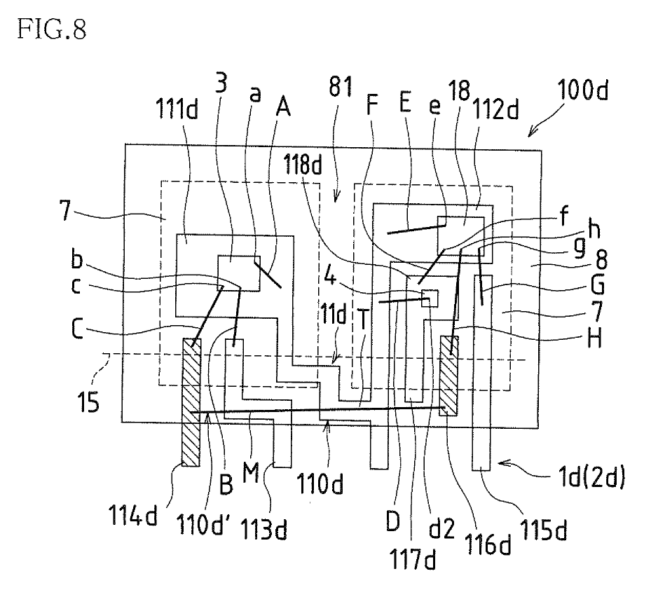

FIG. 7 and FIG. 8 are schematic plan views highlighting one of the lead frames 1c, 1d used in the multi-channel optical coupling device 100c, 100d illustrated in FIG. 4 and FIG. 6 in the case where the common lead 11c, 11d comprises a common second lead portion 110c′, 110d′ shared between the power supply (Vcc) terminal “h” of the emitter-driving element 18 and the power supply (Vcc) terminal “c” of the light receiving element 3.

In the present embodiment, the common second lead portion 110c′, 110d′ comprises a metal wire M, which electrically connects the power supply lead 114c, 114d of the light receiving element 3 and the power supply lead 116c, 116d of the emitter-driving element 18.

In the above-described multi-channel optical coupling devices 100a-100d, the common leads 11a-11d are electrically connected outside of the location of deflection 15 of the lead frames 1a-1d, 2a-2d towards the side carrying the light receiving element 3 or light emitting element 4 and within the secondary package 8. In this configuration, it becomes possible to stably maintain excellent electrical connections between the adjacent optical coupling elements P, P over an extended period of time because the common lead 11a-11d is electrically connected within the secondary package 8.

Moreover, the common lead 11a-11d is preferably electrically connected using at least one means selected from tie bars, leads, or metal wires.

In the present embodiment, the common lead portions 110c, 110d and common lead portions 110a, 100b included in the common leads 11a-11d can be electrically connected using a tie bar T, which is left if tie bar cutting (tie bar removal) is not performed in the lead frame member processing step in the later described multi-channel optical coupling device fabrication method.

Moreover, as previously described, the common second lead portion 110c′, 110d′ included in the common lead 11c, 11d is electrically connected using a metal wire M.

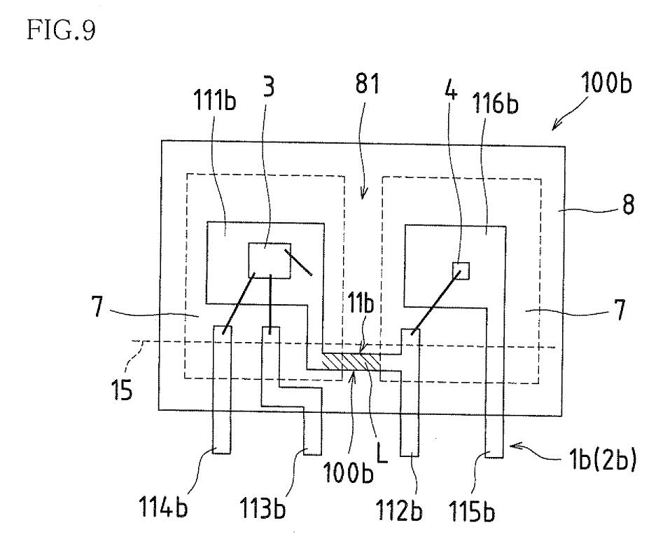

Moreover, typical embodiments also include the ones illustrated in the following FIG. 9-FIG. 12.

FIG. 9 illustrates a state, in which the common lead portion 110b included in the common lead 11b in the multi-channel optical coupling device 100b illustrated in FIG. 3 has been electrically connected using a lead L (see hatched portion) provided in parallel to the tie bar T.

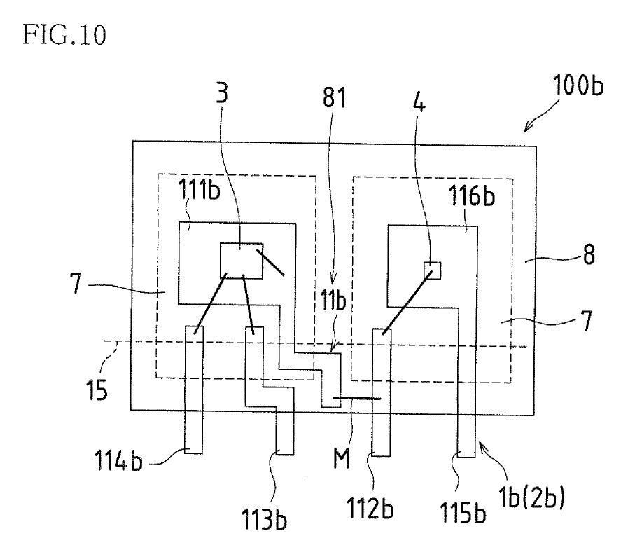

FIG. 10 illustrates a state, in which the common lead portion 110b included in the common lead 11b in the multi-channel optical coupling device 100b illustrated in FIG. 3 has been electrically connected using a metal wire M.

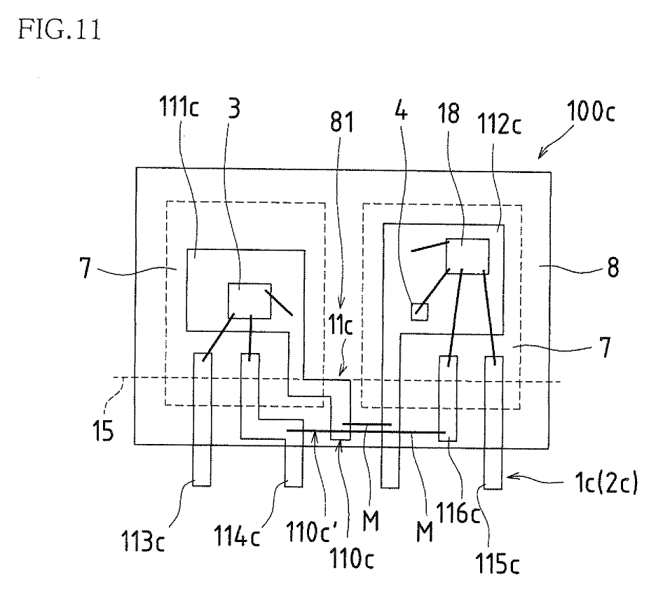

FIG. 11 illustrates a state, in which the common first lead portion 110c included in the common lead 11c in the multi-channel optical coupling device 100c illustrated in FIG. 7 has been electrically connected using a metal wire M.

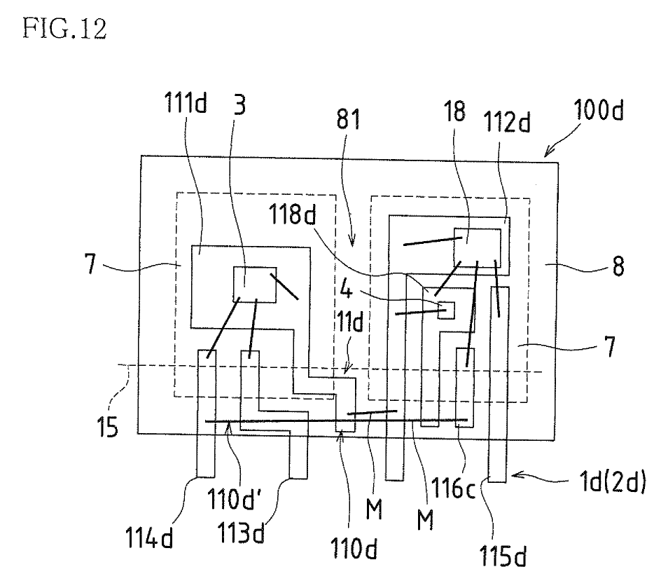

FIG. 12 illustrates a state, in which the common first lead portion 110d included in the common lead 11d in the multi-channel optical coupling device 100d illustrated in FIG. 8 has been electrically connected using a metal wire M.

It should be noted that the metal wire M is maintained in an electrically isolated state with respect to other leads intersecting therewith among the connecting leads.

The above-described multi-channel optical coupling devices 100a-100d can be applied, for instance, to electronic equipments such as power supply equipments, inverter control equipments, and telecommunication equipments used in the communication interfaces of factory automation (FA) equipment.

Next, explanations will be provided regarding the lead frame member according to the present invention and the multi-channel optical coupling device fabrication method according to the present invention. Here, an example is given, in which the multichannel optical coupling device 100b illustrated in FIG. 3 is fabricated as a multi-channel optical coupling device according to the present invention.

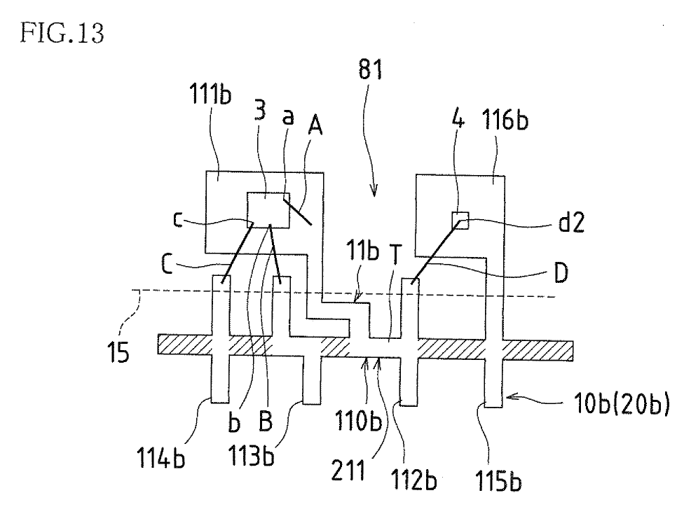

FIG. 13-FIG. 15 are schematic plan views highlighting one of the lead frame members, 10b, among the lead frame members 10a, 10h used in the optical coupling element formation step, primary package formation step, and lead frame member processing step among the steps involved in the fabrication of the multi-channel optical coupling device 100b illustrated in FIG. 3.

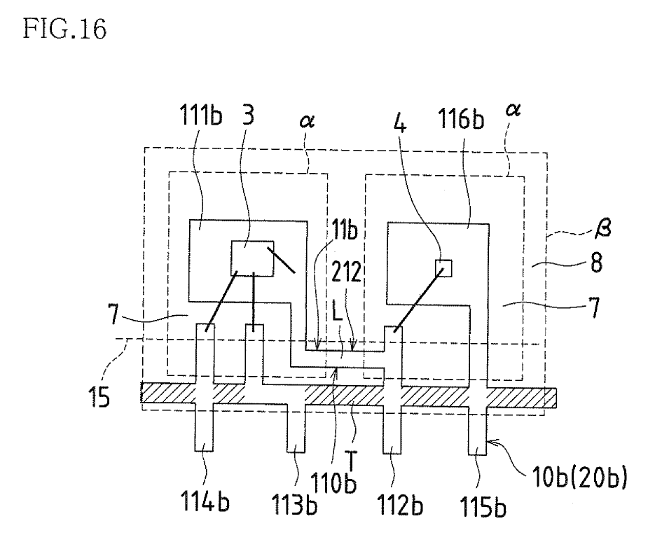

It should be noted that, in FIG. 13-FIG. 15, the configuration of the other lead frame member 20b is substantially identical to the configuration of the first lead frame member 10b and is represented thereby in FIG. 13-FIG. 15. Accordingly, in FIG. 13-FIG. 15, the other lead frame 20b is shown in parentheses after reference numeral 10b. The same is also true with respect to the other lead frames 20a-20d in the later described FIG. 16-FIG. 24.

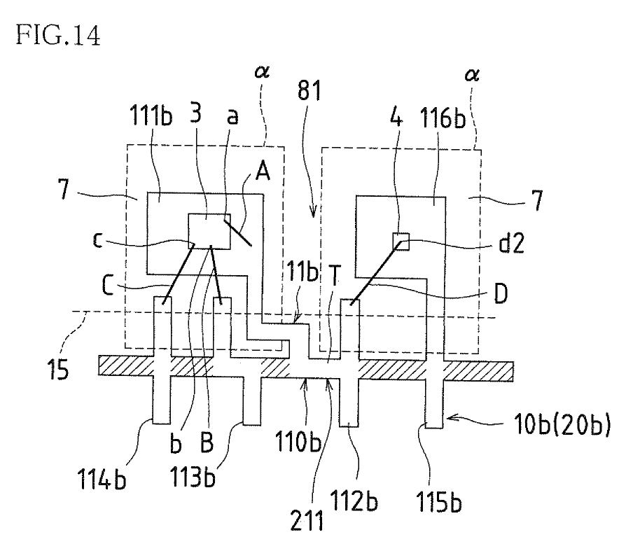

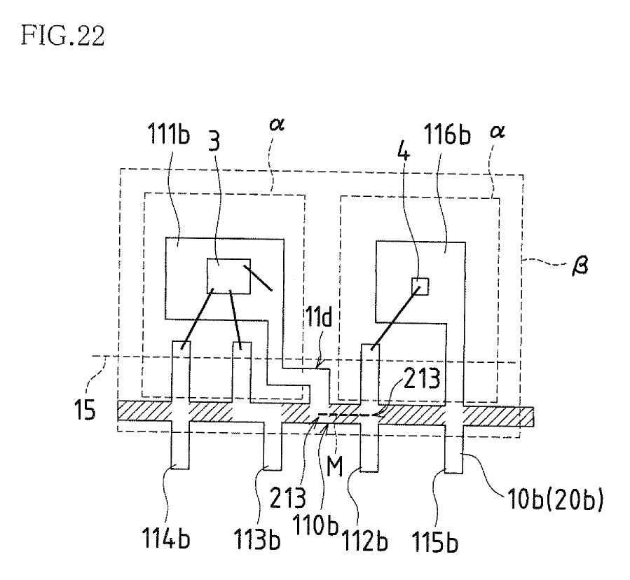

Moreover, the hatched portions of FIG. 13, FIG. 14, FIG. 16-FIG. 19, and FIG. 22-FIG. 24 depict portions where tie bar cutting (tie bar removal) is performed in the later a described lead frame member processing step.

### [Lead Frame Member Preparation]

The first and second lead frame members prepared in this embodiment are used in the multi-channel optical coupling device 100b illustrated in FIG. 3.

In addition, the lead frame members 10b, 20b according to the present invention are employed as at least one of the lead frame member (here, both members) among the first and second lead frame members.

Namely, the lead frame members 10b, 20b used herein are provided with a common lead 11b used to electrically interconnect adjacent optical coupling elements P, P. The lead frame members 10b, 20b have their common lead 11b partially or completely decoupled at the boundary location 81 between the adjacent optical coupling elements P, P.

### [Optical Coupling Element Formation]

Next, light emitting elements 4 and light receiving elements 3 constituting optical coupling elements P are disposed (in an alternating fashion in the present embodiment) on the first lead frame member 10b and the second lead frame member 20b (see FIG. 13), and the first lead frame member 10b and second lead frame member 20b and arranged opposite each other such that the light emitting elements 4 and light receiving elements 3 disposed on the respective lead frame members 10b, 20b form individual optical coupling elements P, P (namely, such that the optical axes of the light emitting elements 4 and light receiving elements 3 coincide).

### [Primary Package Formation]

Primary packages 7, 7 are formed by individually encapsulating the plurality of optical coupling elements P, P in light transmitting resin in a state where the first lead frame member 10b and second lead frame member 20b are arranged opposite each other (see FIG. 14).

### [Lead Frame Member Processing]

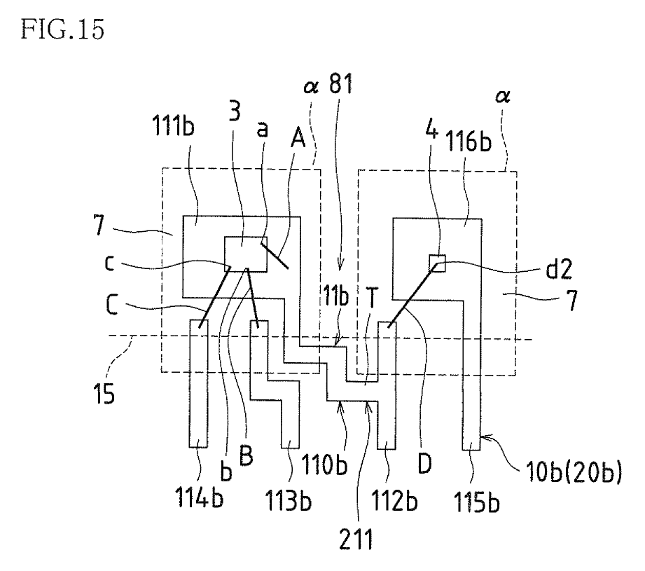

Subsequent to the primary package formation step, the lead frame members 10b, 20b employed in the lead frame member preparation step are processed to a state of electrical interconnection between the adjacent optical coupling elements P, P. In the present embodiment, as later described, the hatched portions shown in FIG. 13 and FIG. 14 are subjected to tie bar cutting (see FIG. 15).

### [Secondary Package Formation]

Subsequently, a secondary package 8 is formed by encapsulating the outside of the individual primary packages 7, 7 in light blocking resin, thereby producing the multi-channel optical coupling device 100b illustrated in FIG. 3.

It should be noted that the fabrication method according to the present invention can include a lead forming step, in which the first and second lead frame members prepared in the lead frame member preparation step are deflected towards the side carrying the light receiving element 3 and light emitting element 4 at a predetermined deflection location 15.

In this manner, according to the lead frame member and the fabrication method for a multichannel optical coupling device of the present invention, it is possible to obtain the multi-channel optical coupling device 10b of the present invention by processing the lead frame members 10b, 20b to a state of electrical interconnection between adjacent optical coupling elements P, P subsequent to forming the primary packages 7. Accordingly, a multi-channel optical coupling device can be obtained that is capable of effectively preventing optical interference between the adjacent optical coupling elements P, P while reducing the number of external terminals.

Moreover, the primary packages 7 and secondary package 8 can be formed using the same molding methods as those used in the past. Accordingly, it becomes possible to implement stable fabrication of multi-channel optical coupling devices.

In the lead frame members 10b and 20b, the common lead 11b comprises a common lead portion 110b shared by the ground terminal “a” of the light receiving element 3 and the cathode terminal “d2” of the light emitting element 4.

Namely, in this manufacturing example, the common lead 11b of the lead frame members 10b and 20b employed in the lead frame member preparation step comprises a common lead portion 110b shared by the ground terminal “a” of the light receiving element 3 and the cathode terminal “d2” of the light emitting element 4. This makes it possible to obtain a multi-channel optical coupling device 100b capable of reducing the number of external terminals associated with the ground terminals “a” of the light receiving elements 3 and the cathode terminals “d2” of the light emitting elements 4.

The case where the common lead 11b in the lead frame members 10b, 20b comprises a common lead portion 110b shared by the ground terminal “a” of the light receiving element 3 and the cathode terminal “d2” of the light emitting element 4, can be exemplified by an embodiment in which, as shown in FIG. 13-FIG. 15, the common lead portion 110b has a header portion 111b carrying the light receiving element 3 and a cathode lead 112b used for the light emitting element 4.

Namely, in this manufacturing example, the common lead portion 110b of the lead frame members 10b and 20b employed in the lead frame member preparation step has a header portion 111b carrying the light receiving element 3 and a cathode lead 112b used for the light emitting element 4. In the optical coupling element formation step, when the light receiving elements 3 are disposed on the corresponding lead frame members 10b, 20b, the ground terminals “a” can be directly attached to the header portion 111b or electrically connected thereto using a metal wire (here, metal wire A) and when the light emitting elements 4 are disposed on the corresponding lead frame members 10b, 20b, the cathode terminals “d2” can be electrically connected to the cathode leads 112b using a metal wire D.

As a result, it becomes possible to mount the light emitting elements 4 such that the anode terminals are directly attached to the corresponding lead frame members 10b, 20b.

To explain this in further detail, the lead frame members 10b, 20b are further provided with an output lead 113b used for the light receiving element 3, a power supply lead 114b used for the light receiving element 3, and an anode lead 115b used for the light emitting element 4.

The anode lead 115b of the light emitting element 4 has a header portion 116b carrying the light emitting element 4. Then, in the optical coupling element formation step, the output (Vo) terminal “b” and power supply (Vcc) terminal “c” of the light receiving element 3 are respectively electrically connected to the output lead 113b and power supply lead 114b of the light receiving element 3 using metal wires B and C. Moreover, the anode terminal of the light emitting element 4 is directly attached to the header portion 116b of the anode lead 115b of the light emitting element 4.

Moreover, the multi-channel optical coupling device 100b illustrated in FIG. 9 may be fabricated using the lead frame members 10b, 20b depicted in FIG. 16 instead of the lead frame members 10b, 20b depicted in FIG. 13-FIG. 15 in the above-described manufacturing example. These lead frame members 10, 20b include the later explained connecting portion 212 incorporating a lead L provided in parallel to the tie bar T.

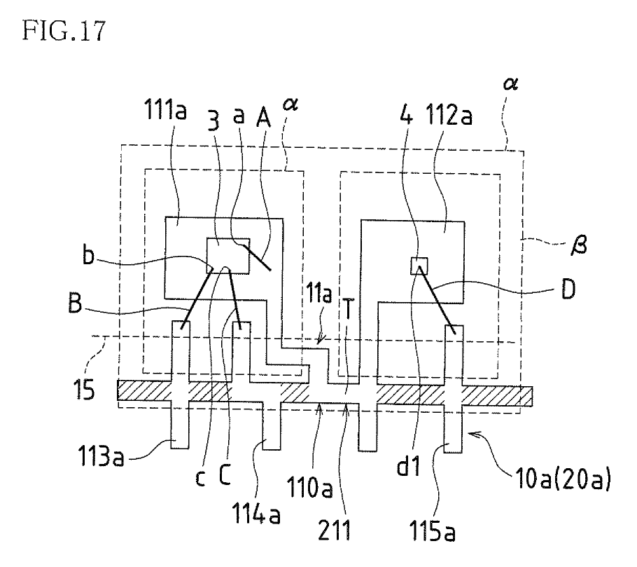

Moreover, the multi-channel optical coupling device 100a illustrated in FIG. 1 and FIG. 2 may be fabricated in the following manner using the lead frame members 10a, 20a depicted in FIG. 17 instead of the lead frame members 10b, 20b depicted in FIG. 13-FIG. 15 in the above-described manufacturing example.

In the lead frame members 10a, 20a illustrated in FIG. 17, the common lead 11a comprises a common lead portion 110a shared by the ground terminal “a” of the light receiving element 3 and the cathode terminal of the light emitting element 4.

This can be exemplified by an embodiment, in which the common lead portion 110a has a first header portion 11a carrying the light receiving element 3 and a second header portion 112a carrying the light emitting element 4.

Namely, in this manufacturing example, the common lead portion 110a of the lead frame members 10a and 20a employed in the lead frame member preparation step has a first header portion 111a carrying the light receiving element 3 and a second header portion 112a carrying the light emitting element 4. In the optical coupling element formation step, when the light receiving elements 3 are disposed on the corresponding lead frame members 10b, 20b, the ground terminals “a” can be directly attached to the first header portion 111a or electrically connected thereto using a metal wire (here, metal wire A) and when the light emitting elements 4 are disposed on the corresponding lead frame members 10a, 20a, the cathode terminals can be directly attached to the second header portion 112a.

As a result, it becomes possible to mount the light emitting elements 4 such that the cathode terminals are directly attached to the corresponding lead frame members 10a, 20a.

To explain this in farther detail, the lead frame members 10a, 20a are further provided with an output lead 113a used for the light receiving element 3, a power supply lead 114a used for the light receiving element 3, and an anode lead 115a used for the light emitting element 4.

Then, in the optical coupling element formation step, the output (Vo) terminal “b” and power supply (Vcc) terminal “c” of the light receiving element 3 are respectively electrically connected to the output lead 113a and power supply lead 114a of the light receiving element 3 using metal wires B and C. Moreover, the anode terminal “d1” of the light emitting element 4 is electrically connected to the anode lead 115a of the light emitting element 4 using a metal wire D.

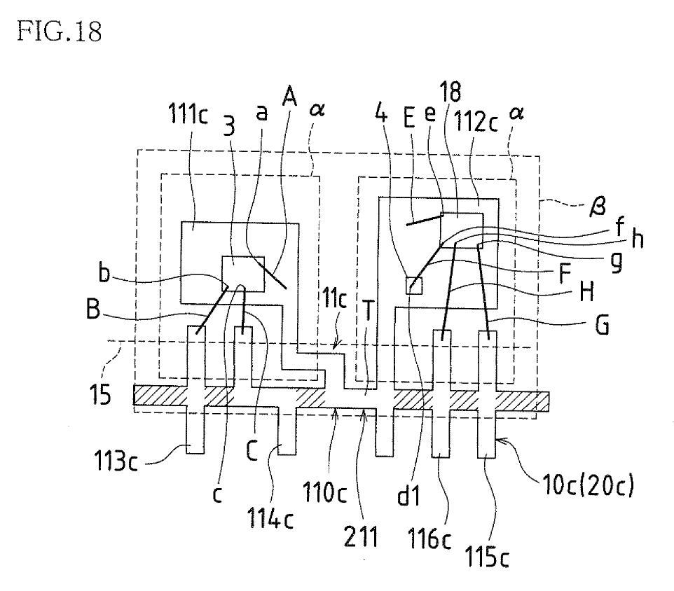

Moreover, the multi-channel optical coupling device 100c illustrated in FIG. 4 may be fabricated in the following manner by using the lead frame members 10c, 20c depicted in FIG. 18 instead of the lead frame members 10b, 20b depicted in FIG. 13-FIG. 15 in the previous manufacturing example.

The lead frame members 10c, 20c illustrated in FIG. 18 are used in the multi-channel optical coupling device 100c illustrated in FIG. 4.

Namely, the first lead frame member 10c and second lead frame member 20c prepared in the lead frame member preparation step in this manufacturing example are used in the multi-channel optical coupling device 100c illustrated in FIG. 4. In the optical coupling element formation step, an emitter-driving element 18 can be disposed on the first lead frame member 10c and second lead frame member 20c. This permits direct driving of the light emitting elements 4 in the optical coupling elements P and, as a result, enables fast response by the light emitting elements 4 and, accordingly, makes it possible to obtain a multi-channel optical coupling device 100c capable of providing high-speed communication response in field networks of FA equipment and the like.

Moreover, the common lead 11c of the lead frame members 10c, 20c employed in the lead frame member preparation step comprises a common first lead portion 110c shared by the ground terminal “e” of the emitter-driving element 18, the ground terminal “a” of the light receiving element 3, and the cathode terminal of the light emitting element 4. This makes it possible to obtain a multi-channel optical coupling device 100c capable of reducing the number of external terminals associated with the ground terminals “e” of the emitter-driving elements 18, ground terminals “a” of the light receiving elements 3 and the cathode terminals of the light emitting elements 4.

Thus, the case where the common lead 11c in the lead frame members 10c, 20c comprises a common first lead portion 110c shared by the ground terminal “e” of the emitter-driving element 18, the ground terminal “a” of the light receiving element 3, and the cathode terminal of the light emitting element 4, can be exemplified by an embodiment in which, as shown in FIG. 18, the common first lead portion 110c has a first header portion 111c carrying the light receiving element 3 and a second header portion 112c carrying both the light emitting element 4 and the emitter-driving element 18.

Namely, in this manufacturing example, the common first lead portion 110c of the lead frame members 10c, 20c employed in the lead frame member preparation step has a first header portion 111c carrying the light receiving element 3 and a second header portion 112c carrying both the light emitting element 4 and the emitter-driving element 18.

In the optical coupling element formation step, when the light receiving elements 3 are disposed on the corresponding lead frame members 10c, 20c, the ground terminals “a” can be directly attached to the first header portion 111c or electrically connected thereto using a metal wire (here, metal wire A). Furthermore, when the light emitting elements 4 and emitter-driving elements 18 are disposed on the corresponding lead frame members 10c, 20c, the cathode terminals of the light emitting elements 4 can be directly attached to the second header portion 112c. Moreover, the ground terminals “e” of the emitter-driving elements 18 can be directly attached to the second header portion 112c or electrically connected thereto using a metal wire (here, metal wire E).

As a result, it becomes possible to mount the light emitting elements 4 such that the cathode terminals are directly attached to the corresponding lead frame members 10b, 20b.

To explain this in further detail, the lead frame members 10c, 20c are further provided with an output lead 113c used for the light receiving element 3, a power supply lead 114c used for the light receiving element 3, an input lead 115c used for the emitter-driving element 18, and a power supply lead 116c used for the emitter-driving element 18.

Then, in the optical coupling element formation step, the output (Vo) terminal “b” and power supply (Vcc) terminal “c” of the light receiving element 3 are respectively electrically connected to the output lead 113c and power supply lead 114c of the light receiving element 3 using metal wires B and C. Moreover, the output (Vo) terminal “f” of the emitter-driving element 18 is electrically connected to the anode terminal “d1” of the light emitting element 4 using a metal wire F. Additionally, the input (Vi) terminal “g” and power supply (Vcc) terminal “h” of the emitter-driving element 18 are respectively electrically connected to the input lead 115c and power supply lead 116c of the emitter-driving element 18 using metal wires G and H.

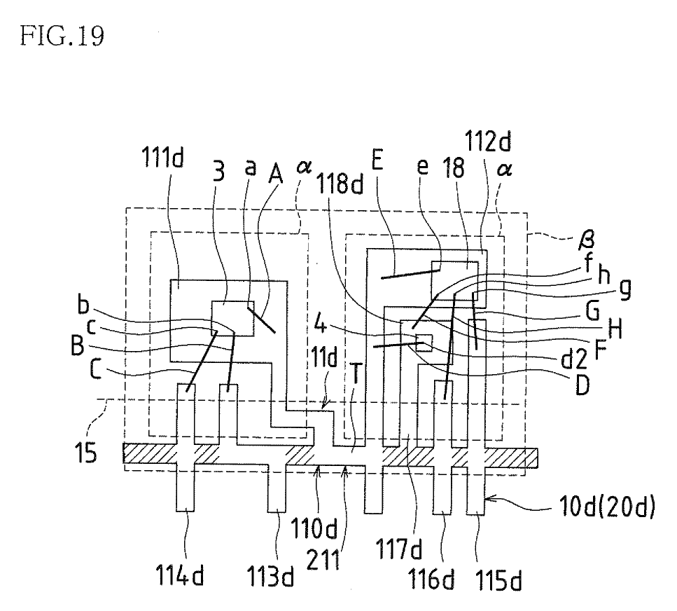

Moreover, the multi-channel optical coupling device 100d illustrated in FIG. 6 may be fabricated in the following manner by using the lead frame members 10d, 20d depicted in FIG. 19 instead of the lead frame members 10b, 20b depicted in FIG. 13-FIG. 15 in the previous manufacturing example.

The lead frame members 10d, 20d illustrated in FIG. 19 are used in the multi-channel optical coupling device 100c illustrated in FIG. 6.

Namely, the first lead frame member 10d and second lead frame member 20d prepared in the lead frame member preparation step in this manufacturing example are used in the multi-channel optical coupling device 100d illustrated in FIG. 6. In the optical coupling element formation step, an emitter-driving element 18 can be disposed on the first lead frame member 10d and second lead frame member 20d.

Moreover, the common lead 11d of the lead frame members 10d, 20d employed in the lead frame member preparation step comprises a common first lead portion 110d shared by the ground terminal “e” of the emitter-driving element 18, the ground terminal “a” of the light receiving element 3, and the cathode terminal “d2” of the light emitting element 4.

Thus, the case where the common lead 11d in the lead frame members 10d, 20d comprises a common first lead portion 110d shared by the ground terminal “e” of the emitter-driving element 18, the ground terminal “a” of the light receiving element 3, and the cathode terminal “d2” of the light emitting element 4, can be exemplified by an embodiment in which, as shown in FIG. 19, the common first lead portion 110d has a first header portion 111d carrying the light receiving element 3 and a second header portion 112d carrying the emitter-driving element 18.

Namely, in this manufacturing example, the common first lead portion 110d of the lead frame members 10d and 20d employed in the lead frame member preparation step has a first header portion 11d carrying the light receiving element 3 and a second header portion 112d carrying the emitter-driving element 18.

In the optical coupling element formation step, when the light receiving elements 3 are disposed on the corresponding lead frame members 10d, 20d, the ground terminals “a” can be directly attached to the first header portion 111d or electrically connected thereto using a metal wire (here, metal wire A). Moreover, when the light emitting elements 4 and emitter-driving elements 18 are disposed on the corresponding lead frame members 10d, 20d, the cathode terminals “d2” can be electrically connected to the second header portion 112d or its lead (here, the lead of the second header portion 112d) using a metal wire D. Moreover, the ground terminals “e” of the emitter-driving elements 18 can be directly attached to the second header portion 112d or electrically connected thereto using a metal wire (here, metal wire E).

As a result, it becomes possible to mount the light emitting elements 4 such that the anode terminals are directly attached to the corresponding lead frame members 10d, 20d.

To explain this in farther detail, the lead frame members 10d, 20d are further provided with an output lead 113d used for the light receiving element 3, a power supply lead 114d used for the light receiving element 3, an input lead 115d used for the emitter-driving element 18, a power supply lead 116d used for the emitter-driving element 18, and an anode lead 117d used for the light emitting element 4.

The anode lead 117d of the light emitting element 4 has a header portion 118d carrying the light emitting element 4. Then, in the optical coupling element formation step, the output (Vo) terminal “b” and power supply (Vcc) terminal “c” of the light receiving element 3 are respectively electrically connected to the output lead 113d and power supply lead 114d of the light receiving element 3 using metal wires B and C. The anode terminal of the light emitting element 4 is directly attached to the header portion 118d of the anode lead 117d of the light emitting element 4. The output (Vo) terminal “f” of the emitter-driving element 18 is electrically connected to the anode lead 117d of the light emitting element 4 or to the header portion 118d of said anode lead 117d (here, the header portion 118d) using a metal wire F. Additionally, the input (Vi) terminal “g” and power supply (Vcc) terminal “h” of the emitter-driving element 18 are respectively electrically connected to the input lead 115d and power supply lead 116d of the emitter-driving element 18 using metal wires G and H.

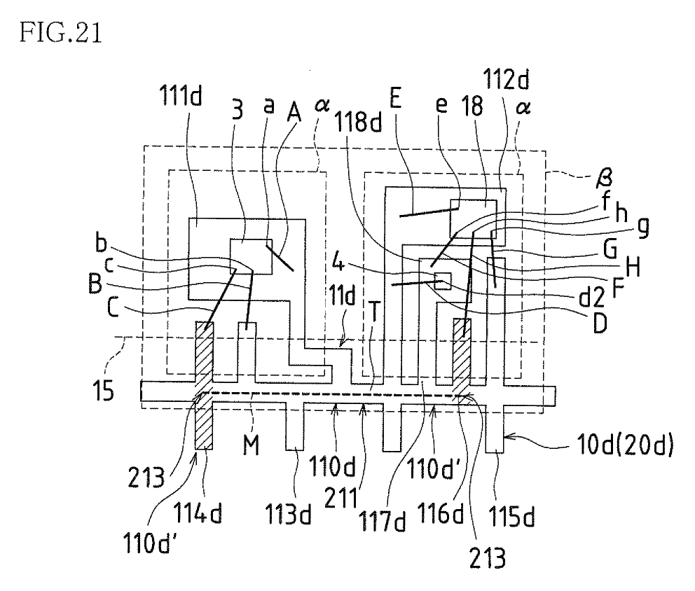

In addition, the case where the multi-channel optical coupling devices 100c, 100d comprise the emitter-driving elements 18 depicted in FIG. 7 and FIG. 8 in the lead frame member according to the present invention, can be exemplified by an embodiment, in which the common lead 11c, 11d comprises, as shown in FIG. 20 and FIG. 21, a common second lead portion 110c′, 110d′ (see the hatched portions in the figures) shared between the power supply (Vcc) terminal “h” of the emitter-driving element 18 and the power supply (Vcc) terminal “c” of the light receiving element 3.

Namely, this can be exemplified by a manufacturing example, in which the lead frame member 10c, 10d employed in the lead frame member preparation step is used in the multi-channel optical coupling device 100c, 100d comprising an emitter-driving element 18 and, along with that, the common lead 11c, 11d comprises a common second lead portion 110c′, 110d′ shared between the power supply (Vcc) terminal “h” of the emitter-driving element 18 and the power supply (Vcc) terminal “c” of the light receiving element 3. This makes it possible to obtain the multi-channel optical coupling devices 100c, 100d of FIG. 7 and FIG. 8 capable of reducing the number of external terminals associated with the power supply (Vcc) terminal “h” of the emitter-driving element 18 and the power supply (Vcc) terminal “c” of the light receiving element 3.

The common leads 11a-11d of the lead frame members 10a-10d, 20a-20d used in the above-described examples of manufacture related to the multi-channel optical coupling devices 100a-100d comprise connecting portions 211-213 that can be electrically connected outside of the location of deflection 15 towards the side carrying the light receiving element 3 or the light emitting element 4 and within the region β (referred to as secondary cavity region β below) corresponding to the secondary package 8. It should be noted that, in FIG. 16-FIG. 24, the symbol a indicates regions corresponding to primary packages.

Namely, the common leads 11a-11d of the lead frame members 10a-10d, 20a-20d used in the lead frame member preparation step in the this example of manufacture comprise connecting portions 211-213 that can be electrically connected outside of the location of deflection 15 of the lead frame members 10a-10d, 20a-20d towards the side carrying the light receiving element 3 or light emitting element 4 and within the secondary cavity region P. As a result, it becomes possible to stably maintain excellent electrical connections between the adjacent optical coupling elements P, P over an extended period of time because the common leads 11a-11d are electrically connected within the secondary cavity region β.

To explain this in further detail, the connecting portion 211 of the lead frame members 10a-10d, 20a-20d illustrated in FIG. 13-FIG. 15 and FIG. 17-FIG. 21 is in a location having incorporated therein a tie bar T electrically interconnecting the adjacent optical coupling elements P, P.

The connecting portion 212 of the lead frame members 10b, 20b illustrated in FIG. 16 is in a location having incorporated therein a lead L electrically interconnecting the adjacent optical coupling elements P, P.

As described above, the lead frame members 10c-10d, 20c-20d illustrated in FIG. 20 and FIG. 21 are used, respectively, in the multi-channel optical coupling devices 100c and 100d illustrated in FIG. 7 and FIG. 8.

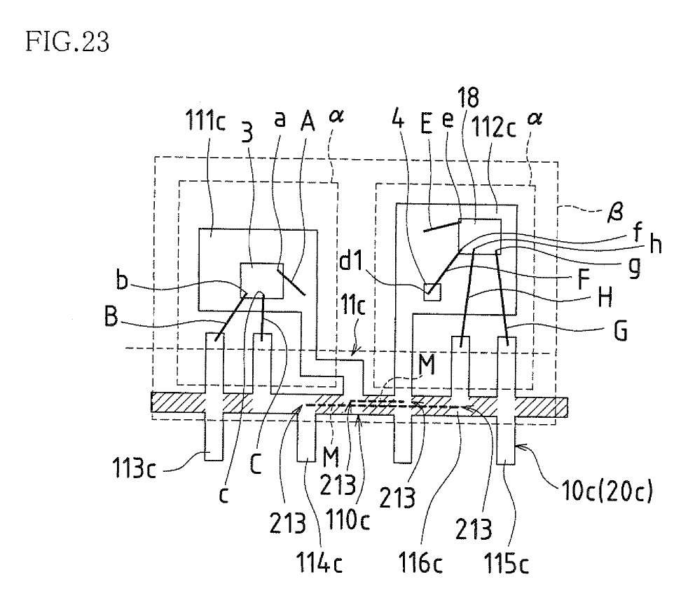

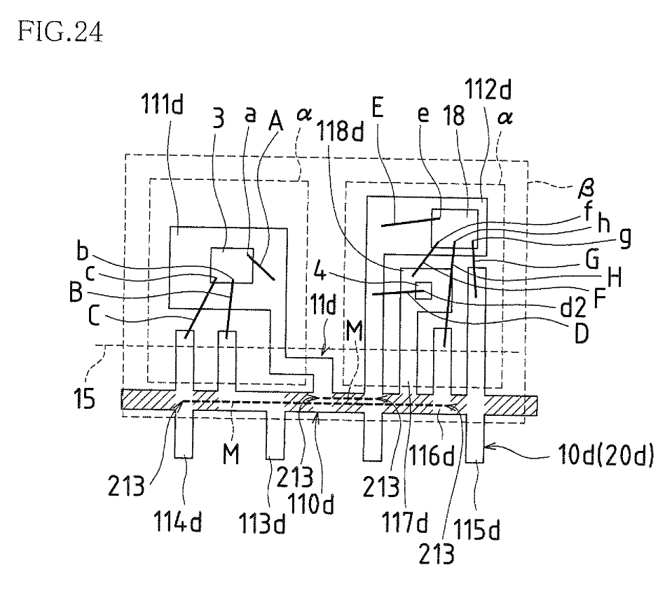

Furthermore, FIG. 22 is a schematic plan view highlighting one of the lead frame members, 10b, used in the multi-channel optical coupling device 100b illustrated in FIG. 10. FIG. 23 and FIG. 24 are schematic plan views respectively highlighting lead frame members 10c and 10d used in the multi-channel optical coupling devices 100c and 100d illustrated in FIG. 11 and FIG. 12.

The connecting portion 213 of the lead frame members 10b-10d, 20b-20d illustrated in FIG. 20-FIG. 24 is in a location where it is possible to provide a meal wire M electrically interconnecting the adjacent optical coupling elements P, P.

Thus, when the common lead 11a-11d comprises the connecting portion 211-213, in this manufacturing example, the connecting portion of the lead frame member employed in the lead frame member preparation step comprises at least one location selected from among a location having incorporated therein a tie bar T electrically interconnecting the adjacent optical coupling elements P, P and a location having incorporated therein a lead L electrically interconnecting the adjacent optical coupling elements P, P, and, in the lead frame member processing step, tie bar cutting can be carried out such that at least one of either the tie bar T or the lead L is left intact.

Alternatively, or additionally, the connecting portion of the lead frame member employed in the lead frame member preparation step comprises a location 213 where it is possible to provide a metal wire M electrically interconnecting the adjacent optical coupling elements P, P, and the metal wire M can be provided in the connecting portion 213 in the lead frame member processing step. Doing so makes it possible to simply and easily implement electrical connections between the adjacent optical coupling elements P, P.

It should be noted that the lead frame member processing step, prior to the step of providing a metal wire M in the connecting portion 213, may further include a step of cleaning the connecting portion 213.

While the discussion above provided examples of bidirectional multi-channel optical coupling devices, the present invention is not limited thereto and can be applied to unidirectional coupling devices as well.

The present invention can be implemented in a variety of other forms without departing from its gist or essential features. For this reason, the above-described embodiments are to all intents and purposes merely illustrative and should not be construed as limiting. The scope of the present invention is defined by the claims and is not restricted by the description of the specification in any way. Furthermore, all variations and modifications of the claims within the scope of equivalency fall within the purview of the present invention.

What is claimed is:

1. A multi-channel optical coupling device in which a plurality of optical coupling elements, each respectively comprising a light emitting element and a light receiving element, are placed side-by-side between a pair of lead frames arranged mutually opposite each other, the plurality of optical coupling elements are encapsulated in primary packages of light transmitting resin, and the outside of the individual primary packages is encapsulated in a secondary package of light blocking resin,
wherein at least one lead frame of the pair of lead frames is provided with a common lead used to electrically interconnect adjacent optical coupling elements among the plurality of optical coupling elements, with the common lead being partially decoupled at the boundary location between the adjacent optical coupling elements.

2. The multi-channel optical coupling device according to claim 1,
wherein the light emitting elements and light receiving elements are arranged opposite to and alternating with each other between the pair of lead frames.

3. The multi-channel optical coupling device according to claim 2,
wherein the common lead comprises a common lead portion shared between a ground terminal of the light receiving element and a cathode terminal of the light emitting element.

4. The multi-channel optical coupling device according to claim 3,
wherein the common lead portion has a first header portion carrying the light receiving element and a second header portion carrying the light emitting element,
the ground terminal of the light receiving element is electrically connected to the first header portion, and the cathode terminal of the light emitting element is directly attached to the second header portion.

5. The multi-channel optical coupling device according to claim 3,
wherein the common lead portion has a header portion carrying the light receiving element and a lead used for the cathode of the light emitting element,
the ground terminal of the light receiving element is electrically connected to the header portion, and the cathode terminal of the light emitting element is electrically connected to the cathode lead using a metal wire.

6. The multi-channel optical coupling device according to claim 2,
wherein each of the plurality of optical coupling elements respectively includes an emitter-driving element that drives the light emitting element, and
the common lead comprises a common lead portion shared between a ground terminal of the emitter-driving element, a ground terminal of the light receiving element, and a cathode terminal of the light emitting element.

7. The multi-channel optical coupling device according to claim 6,
wherein the common lead portion has a first header portion carrying the light receiving element and a second header portion carrying both the light emitting element and the emitter-driving element,
the ground terminal of the light receiving element is electrically connected to the first header portion, the cathode terminal of the light emitting element is directly attached to the second header portion, and the ground terminal of the emitter-driving element is electrically connected to the second header portion.

8. The multi-channel optical coupling device according to claim 6,
wherein the common lead portion has a first header portion carrying the light receiving element and a second header portion carrying the emitter-driving element,
the ground terminal of the light receiving element is electrically connected to the first header portion, the cathode terminal of the light emitting element is electrically connected to the second header portion or to a lead of the second header portion using a metal wire, and the ground terminal of the emitter-driving element is electrically connected to the second header portion.

9. The multi-channel optical coupling device according to claim 2,
wherein each of the plurality of optical coupling elements respectively includes an emitter-driving element that drives the light emitting element, and
the common lead comprises a common lead portion shared between a power supply terminal of the emitter-driving element and a power supply terminal of the light receiving element.

10. The multi-channel optical coupling device according to claim 1,
wherein the common lead is electrically connected outside of the location of deflection of the lead frame towards the element-carrying side and within the secondary package.

11. The multi-channel optical coupling device according to claim 10,
wherein the common lead is electrically connected using at least one of a tie bar, lead, or metal wire.

12. An electronic equipment comprising the multi-channel optical coupling device according to claim 1.

13. A lead frame member, which is used in a multi-channel optical coupling device in which a plurality of optical coupling elements, each respectively comprising a light emitting element and a light receiving element, are placed side-by-side between a pair of lead frames arranged mutually opposite each other, the plurality of optical coupling elements are encapsulated in primary packages of light transmitting resin, and the outside of the individual primary packages is encapsulated in a secondary package of light blocking resin,
wherein there is provided a common lead used to electrically interconnect adjacent optical coupling elements among the plurality of optical coupling elements, and the common lead is at least partially decoupled at the boundary location between the adjacent optical coupling elements.

14. The lead frame member according to claim 13, which is used in the multi-channel optical coupling device in which the light emitting elements and light receiving elements are arranged opposite to and alternating with each other between the pair of lead frames.

15. The lead frame member according to claim 13,
wherein the common lead comprises a connecting portion that can be electrically connected outside of the location of deflection towards the element-carrying side and within a region corresponding to the secondary package.

16. The lead frame member according to claim 15,
wherein the connecting portion comprises at least one location selected from among a location having incorporated therein a tie bar electrically interconnecting the adjacent optical coupling elements, a location having incorporated therein a lead electrically interconnecting the adjacent optical coupling elements, and a location where it is possible to provide a metal wire electrically interconnecting the adjacent optical coupling elements.

17. A fabrication method for a multi-channel optical coupling device in which a plurality of optical coupling elements, each respectively comprising a light emitting element and a light receiving element, are placed side-by-side between a pair of lead frames arranged mutually opposite each other, the plurality of optical coupling elements are encapsulated in primary packages of light transmitting resin, and the outside of the individual primary packages is encapsulated in a secondary package of light blocking resin, the fabrication method comprising:
a lead frame member preparation step, which involves preparing first and second lead frame members, and, as at least one lead frame member among the first and second lead frame members, employing a lead frame member in which a common lead is provided that electrically interconnects adjacent optical coupling elements among the plurality of optical coupling elements and the common lead is at least partially decoupled at the boundary location between the adjacent optical coupling elements;
an optical coupling element formation step, which involves forming the plurality of optical coupling elements by placing light emitting elements and light receiving elements constituting the optical coupling elements on the first and second lead frame members;
a primary package formation step, which involves forming the primary packages by individually encapsulating the plurality of optical coupling elements with light transmitting resin;
a lead frame member processing step, which involves, subsequent to the primary package formation step, processing the lead frame member employed in the lead frame member preparation step to a state of electrical interconnection between the adjacent optical coupling elements; and
a secondary package formation step, which involves forming the secondary package by encapsulating the outside of the individual primary packages with light blocking resin.

18. The fabrication method for a multi-channel optical coupling device according to claim 17,
wherein the first and second lead frame members prepared in the lead frame member preparation step are used in a multi-channel optical coupling device having the light emitting elements and the light receiving elements arranged opposite to and alternating with each other between the pair of lead frames, and
in the optical coupling element formation step, the light emitting elements and light receiving elements are placed on the first and second lead frame members in an alternating fashion.

19. The fabrication method for a multi-channel optical coupling device according to claim 17,
wherein the common lead of the lead frame member employed in the lead frame member preparation step comprises a connecting portion that can be electrically connected outside of the location of deflection of the lead frame member towards the element-carrying side and within a region corresponding to the secondary package.

20. The fabrication method for a multi-channel optical coupling device according to claim 19,
wherein the connecting portion of the lead frame member employed in the lead frame member preparation step comprises at least one location selected from among a location having incorporated therein a tie bar electrically interconnecting the adjacent optical coupling elements and a location having incorporated therein a lead electrically interconnecting the adjacent optical coupling elements, and
in the lead frame member processing step, tie bar cutting is carried out such that at least one of the tie bar and the lead is left intact.

21. The fabrication method for a multi-channel optical coupling device according to claim 19,
wherein the connecting portion of the lead frame member employed in the lead frame member preparation step comprises a location where it is possible to provide a metal wire electrically interconnecting the adjacent optical coupling elements and
the metal wire is provided in the connecting portion in the lead frame member processing step.
